(19) United States
(12) Patent Application Publication
(10) Pub. No.: US 2007/0174843 A1
(43) Pub. Date: Jul. 26, 2007

(54) Distributed memory type information processing system

(76) Inventor: Shinji Furusho, Kanagawa (JP)

Correspondence Address: GRIFFIN & SZIPL, PC, SUITE PH-1, 2300 NINTH STREET, SOUTH, ARLINGTON, VA, 22204, US

(21) Appl. No.: 10/595,510

(22) PCT Filed: Oct. 19, 2004
(86) PCT No.: PCT/JP04/15437

§ 371 Date: Jan. 29, 2007

(30) Foreign Application Priority Data
Oct. 24, 2003 (JP) 2003-364218

(51) Int. Cl. G06F 9/46

(52) U.S. Cl. 719/318

(57) ABSTRACT

The invention relates to a distributed memory type arrangement, wherein elements stored in various memories are inputted/outputted with unified processing and communication. The system includes a data transmission route for transmitting a value of a memory module to another memory module. A PMM memory has a list of values arranged in ascending order or descending order without duplication. A PMM control device includes: data transmission means for transmitting a value contained in the value list to another memory module; data reception means for receiving a value contained in the value list; and order judgment means for deciding the global value order and storing the decided order at the position corresponding to its memory module value in the global order storage arrangement for storing the global value order.

### TECHNICAL FIELD

This invention relates to an image processing system employing a parallel computer architecture that can realize SIMD (Single Instruction Stream, Multiple Data Stream).

### BACKGROUND ART

Today, as computers have been introduced to various places in the whole society and networks such as the Internet have been spread, large-scaled data are stored here and there. To process such large-scale data, an enormous amount of calculation is necessary and it is natural that one should try to introduce parallel processing for this.

Parallel processing architectures are roughly classified into “shared memory type” and “distributed memory type”. The former (“shared memory type”) is a system in which plural processors share one huge memory space. In this system, since the traffic between the processor group and the shared memory is a bottleneck, it is not easy to construct a practical system using more than a hundred processors. Therefore, for example, when calculating the square root of one billion floating point variables, the acceleration ratio for a single CPU is at most a hundred times. Experience shows that approximately thirty times is the upper limit.

In the latter (“distributed memory type”), the processors have their respective local memories and these memories are connected to construct a system. In this system, it is possible to design a hardware system incorporating several hundred to tens of thousands of processors. Therefore, the acceleration ratio for a single CPU when calculating the above-described square root of one billion floating point variables can be several hundred to tens of thousands times. However, the latter, too, has several problems as follows.

[Patent Reference 1]

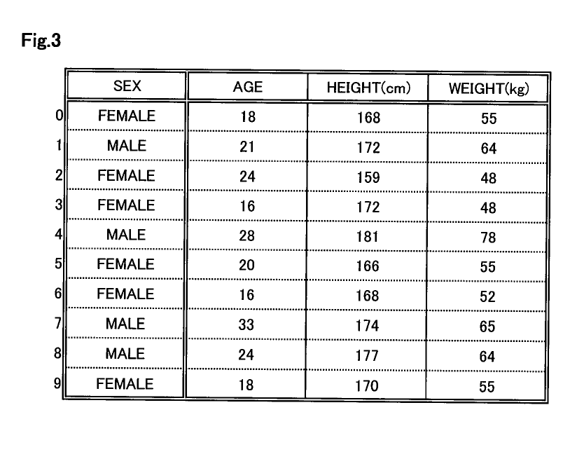

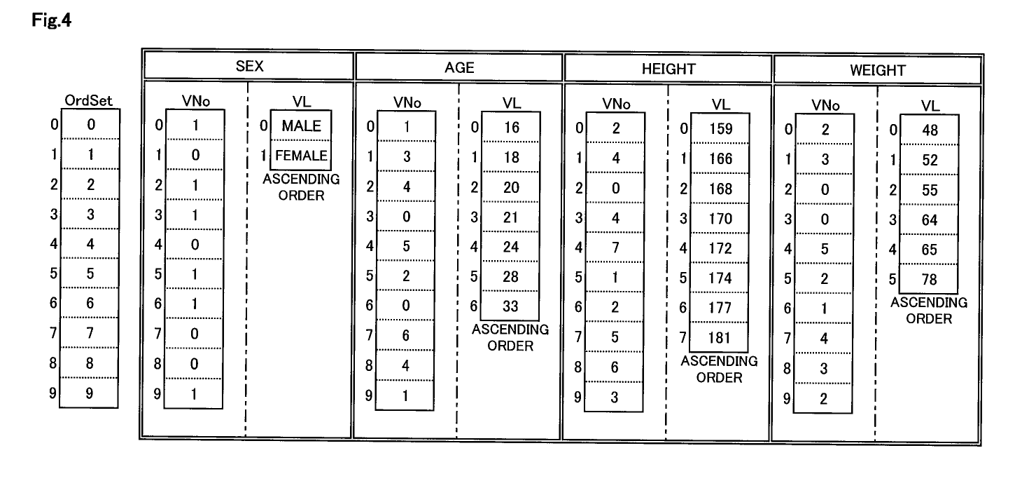

Brochure of WO00/10103 (FIG. 3 and FIG. 4)

### DISCLOSURE OF THE INVENTION

### Problems that the Invention is to Solve

[First Problem: Distributive Control and Management of Gigantic Array]

The first problem of the “distributed memory type” is the problem of distributive control and management of data.

Huge data (since it is an array generally, it will be described as array hereinafter) cannot be housed in a local memory possessed by one processor and is necessarily controlled and managed distributively in plural local memories. Unless an efficient and flexible distributive control and management mechanism is introduced, it is clear that various troubles occur when developing and executing programs.

[Second Problem: Low Efficiency of Communication between Processors]

If each processor in a distributed memory type system tries to access a huge array, the processor can quickly access array elements on a local memory it possesses, but requires communication between processors to access array elements possessed by the other processors. This communication between processors is extremely low in performance, compared with communication with the local memory, and it is said that this communication takes at least 100 clocks. Therefore, when carrying out sorting, reference over the entire area of the gigantic array is carried out and many communications between processors take place. Thus, the performance is lowered extremely.

With respect to this problem, more specific explanation will be given. As of 1999, a personal computer is constructed as a “shared memory type” using one to several CPUs. A standard CPU used in this personal computer operates at an internal clock that is approximately five to six times a memory bus, and automatic parallel execution function and pipeline processing function are provided therein. Thus, it can process one data at one clock (memory bus).

Therefore, in the multi-processor system of the “distributed memory type”, the number of processors is large but the operation can be a hundred times slower than a single processor (shared memory type).

[Third Problem: Provision of Program]

The third problem of the “distributed memory type” is how a program can be provided to many processors.

In a system (MIMD: Multiple Instruction Stream, Multiple Data Stream) where individual programs are loaded to a very large number of processors and they are caused to operate in cooperation as a whole, it takes large burden to prepare, compile and distribute the program.

On the other hand, in the system (SIMD: Single Instruction Stream, Multiple Data Stream) where many processors are caused to operate with the same program, the degree of freedom in the program is reduced and a situation may be anticipated that a program capable of realizing a desired result cannot be developed.

This invention provides a method and computer architecture to solve the above-described first to third problems of the “distributed memory type”.

Meanwhile, the present inventor has worked out a structure and processing method of forming an information block for each entry in order to store spreadsheet data, then providing the information block with a value list storing entry values and a pointer array storing a value (pointer value) for designating the value list for each record, and sequentially specifying the pointer array and the value list from the record numbers, thereby enabling acquisition of a spreadsheet view (see Patent Reference 1). In this structure, as the number of records increases, the value list and the pointer array increase and particularly the pointer array increases very much. Therefore, it is desirable to distributively control these in plural memories and then execute processing such as search, totaling and sorting by a single command.

Thus, it is an object of this invention to provide a computer architecture that can realize very high-speed parallel processing, by inputting and outputting elements of an array stored in various memories by a single command in the distributed memory type and thus integrating processing and communication.

### Means for Solving the Problems

The object of this invention is achieved by an information processing system having plural memory modules, each having a memory and a control device, and

a data transmission line that connects the memory modules and transmits a value of one memory module to another memory module,

the memory of each memory module being arranged to hold a value list having values ordered in ascending order or descending order without duplication,

the information processing system being characterized in that the control device of each of the memory modules comprises:

data transmitting means that transmits a value contained in the value list to the other memory modules;

data receiving means that receives a value contained in the value list from the other memory modules; and

rank judging means that decides a global value rank in consideration of the values contained in the value lists of all the other memory modules, with reference to the value lists of the other memory modules received by the data receiving means, and stores the decided rank at a position corresponding to the value in the present memory module, in a global rank storage array for storing the global value rank.

According to this invention, by comparing the value in the value list of the present memory module with the value lists of the other memory modules, it is possible to acquire the global rank of the value in the value list of the present memory module in consideration of the values in the value lists of the other memory modules.

In a preferred embodiment, the rank judging means generates an auxiliary rank storage array in consideration of the value list of each of the other memory modules, combines values in the auxiliary rank storage array, and decides the value in the rank storage array. Particularly, as the rank judging means generates the auxiliary rank storage array in parallel, significantly high-speed processing can be realized.

Also, in a preferred embodiment, the data transmission line connects the adjacent modules and forms a ring shape data transmission line.

In another preferred embodiment, the data transmission line has a first data transmission line having one or more channels that transmit data from one memory module to the other memory module, and a second data transmission line having one or more channels that transmit data from the other memory module to the one memory module,

the data transmitting means is arranged to transmit the value list of the present memory module between the adjacent memory modules by using either the one or the other data transmission line defined as a channel for each memory module, and

the data receiving means is arranged to receive the value list of the other memory module from a defined channel by utilizing the one and the other transmission lines, in parallel with the data transmission by the data transmitting means.

According to this embodiment, data is transmitted, in parallel, to the channel defined for each memory module of the first data transmission line and the second transmission line, and in each memory module, the rank of the value contained in the local value list controlled by the present memory module can be decided in consideration of the rank of the value lists of the other memory modules. Therefore, in each memory module, it is possible to properly grasp the position or rank of a subset controlled by the present memory module, of a set including the entire value list of the memory module. As the position or rank is thus grasped, search and sorting processing, which will be described later, can be smoothly realized.

In another preferred embodiment, in order to realize spreadsheet data expressed as an array of records each containing an entry and entry values belonging to the entry, the memory of each of the memory modules holds an information block including a value list in which the entry values are stored in order of entry value numbers corresponding to entry values belonging to a specific entry, and a pointer array in which pointer values for designating the entry value numbers are stored in order of a unique order set array, wherein a group of the information blocks held by the respective memories forms a global information block,

the control device of each memory module comprises offset value storage means that holds an offset value indicating which position of the pointer array is occupied by the information block controlled by the present memory module, as a subset of the global information block, and

global order set array generating means that generates a global order set array in the global information block on the basis of the offset value, and

the rank judging means decides the global value rank in the value list, as the value list, and stores the decided rank in a global value number array equivalent to the global rank storage array.

In a more preferred embodiment, the rank judging means is arranged to generate an auxiliary value number array that stores a relative value rank in consideration of the value list of each of the other memory modules, and add the sum of the difference between the relative rank and the original rank judged for each of the other memory modules, to the original rank, thereby calculating the global value rank.

Alternatively, every time the value lists of the other memory modules are received, the difference between a new relative rank and the original rank may be calculated and this value may be sequentially accumulated, thus calculating the global rank.

In a more preferred embodiment, there is further provided same value erasing means that erases the same value from the value list received by the data receiving means if the same value as the entry value in the value list of the present memory module exists among the entry values in the value list received.

In another preferred embodiment, the control device of each memory module comprises:

flag array setup means that generates, with respect to an entry to be searched for, a flag array of the same size as the value list of the entry, and provides a specific value in a flag array corresponding to an entry value that meets a search condition;

search condition judging means that specifies a value in the pointer array corresponding to the position indicated by the order set array, with respect to the entry to be searched for, and after that, specifies a value in the flag array corresponding to the position indicated by the value in the pointer array, thereby judging whether a record corresponding to the value in the order set array meets the search condition or not; and

local search means that stores a value in the order set meeting the search condition and a value in the corresponding global order set into a second order set array and a second global order set array, respectively.

The data transmitting means transmits the second global order set array as the value list to the other modules, and the data receiving means receives the second global order set array as the value list from the other memory modules.

There is also provided second rank judging means that judges a relative rank of the present memory module's value in the global order set array with respect to the other memory modules with reference to each of the received second global order set arrays, decides a rank in the global information block on the basis of the relative rank, and stores the rank in the global information block into a third global order set array equivalent to the global rank storage array. The rank of a record that meets the search condition is indicated by the value in the third global order set array.

In a more preferred embodiment, the second rank judging means is arranged to generate an auxiliary order set array that stores relative value ranks in consideration of the second global order set array of each of the other memory modules, and add the sum of the difference between the relative rank and the original rank judged for each of the other memory modules, to the original rank, thereby calculating the rank of the value in the global information block.

Also, in a preferred embodiment, the control device of each memory module comprises third rank judging means that decides the rank of the value in the global order set array in accordance with a value corresponding to the global order set array, of a global value number array related to a predetermined entry, and stores the value in the global order set array at a position corresponding to the decided rank, in a fourth global order number array. The fourth global order set array is formed by rearranging the global order set in accordance with the value in the global value number array.

In still another preferred embodiment, the control device of each memory module comprises:

number-of-existence array generating means that generates, with respect to an entry to be sorted, a number-of-existence array of the same size as the value list of the entry, and arranges the number of values in the order set array that designate each of the entry values in the value list;

cumulative sum array generating means that accumulates the values in the number-of-existence array, calculates the cumulative sum indicating the leading position of a record having the corresponding entry value when sorted within the memory module, and arranges the cumulative sum in a cumulative sum array; and

local sorting means that generates a second global value number array, the fourth global order set array and a third order set array, and arranges, on the basis of the cumulative sum in the cumulative sum array corresponding to the entry value indicated by the value in the order set array, a global value number corresponding to entry value at a position indicated by the cumulative sum in the second global value number array, and arranges the value in the order set array and the value in the corresponding global order set array at positions indicated by the cumulative sum in the third order set array and the fourth global order set array, respectively.

The data transmitting means transmits at least a second global value number array as the value list, and the data receiving means receives second global value number arrays of the other memory modules as the value list.

There is also provided fourth rank judging means that judges a relative rank of the present memory module's value in the second global value number array with respect to the other memory modules with reference to each of the received second global value number arrays, and stores the rank in the global information block into a fifth global order set array equivalent to the global order storage array. The rank of the sorted record is indicated by the value in the fifth global order set array.

In a more preferred embodiment, the fourth rank judging means is arranged to generate an auxiliary order set array that stores a relative value rank in consideration of the second global value number array of each of the other memory modules, and add the sum of the difference between the relative rank and the original rank judged for each of the other memory modules, to the original rank, thereby calculating the rank in the global information block.

The object of this invention is achieved by each memory module having steps corresponding to the respective means in the information processing system.

For example, in one embodiment, in an information processing system comprising

plural memory modules, each having a memory and a control device, and

a data transmission line that connects the memory modules and transmits a value of one memory module to another memory module,

the memory of each memory module being arranged to hold a value list having values ordered in ascending order or descending order without duplication,

the information processing method being characterized by comprising, in each memory module:

a data transmitting step of transmitting a value contained in the value list to the other memory modules;

a data receiving step of receiving a value contained in the value list from the other memory modules; and

a rank judging step of deciding a global value rank in consideration of the values contained in the value lists of all the other memory modules, with reference to the value lists of the other memory modules received at the data receiving step, and storing the decided rank at a position corresponding to the value in the present memory module, in a global rank storage array for storing the global value rank.

Moreover, in this invention, an information processing system is provided that includes plural information processing units, each having a memory and a control device, and in which the memory of each of the information processing units holds spreadsheet data expressed as an array of records, each containing an entry and an entry value belonging to the entry, and in which global spreadsheet data is formed by an aggregate of spreadsheet data held by each memory module,

the information processing system being characterized in that each of the information processing units comprises a global order set array that houses a value indicating the rank of each record in the global spreadsheet data, and record extracting means that specifies a value in the global order set array in accordance with a command designating the rank received by the control device and extracts the record indicated by the value.

According to this invention, the information processing unit including processor memory module (PMM), personal computer, server or the like can be caused to distributively control and grasp local spreadsheet data, and the information processing unit can be caused to individually execute local search and totaling. Also, as the global order set array is provided, it is possible to realize search of global spreadsheet data. A single personal computer or server may correspond to a single information processing unit, and a construction in which plural information processing units are included in a single personal computer or server may be employed.

In a preferred embodiment, the information processing unit comprises another order set array in which values specifying records have been replaced, in order to reflect the sorting order within the information processing unit. In the global order set array, to indicate the sorting order in the global spreadsheet data, of the records indicated by the values in another order set array, the values indicating their ranks are rearranged. The values rearranged in this global order set array are in ascending order.

Alternatively, the information processing unit may be arranged so that, in the global order set array, to indicate the sorting order in the global spreadsheet data, of the records sorted within the information processing unit, the values indicating their ranks are rearranged. Again, the values rearranged in the global order set array are in ascending order. In this manner, this invention can be applied to an embodiment in which values specifying records are sorted and housed in another order set array, and this invention can also be applied to an embodiment in which records themselves are rearranged by sorting.

In another preferred embodiment, the memory of each of the information processing units holds an information block including a value list for expressing spreadsheet data represented as an array of records each containing an entry and an entry value belonging to the entry, the value list storing the entry values in order of entry value number corresponding to entry values belonging to specific entries, and a pointer array storing pointer values for indicating the entry value numbers in order of a univocal order set array. A global information block is formed by an aggregate of the information blocks held by the respective memories.

Moreover, in this invention, an information processing system is provided that includes plural information processing units, each having a memory and a control device, and in which the memory of each of the information processing units holds an information block including a value list for expressing spreadsheet data represented as an array of records each containing an entry and an entry value belonging to the entry, the value list storing the entry values in order of entry value number corresponding to entry values belonging to specific entries, and a pointer array storing pointer values for indicating the entry value numbers in order of a univocal order set array, and in which a global information block is formed by an aggregate of the information blocks held by the respective memories,

the information processing system being characterized in that the information processing unit comprises a global value number array that houses a value indicating the rank of an entry value in the global information block, and entry value extracting means that specifies a value in the global value number array in accordance with a command designating the rank received by the control device and extracts the entry value in the value list indicated by the value.

Also, the object of this invention is achieved by an information processing system having plural memory modules, each having a memory and a control device, and

a data transmission line that connects the memory modules and transmits a value of one memory module to another memory module,

the memory of each memory module being arranged to hold a value list,

the information processing system being characterized in that the control device of each of the memory modules comprises:

data transmitting means that transmits a value contained in the value list to the other memory modules;

data receiving means that receives a value contained in the value list from the other memory modules; and

rank judging means that decides a global value rank in consideration of a value contained in the value lists of all the other memory modules, with reference to the value lists of the other memory modules received by the data receiving means, and stores the decided rank at a position corresponding to the value in the present memory module, in a global rank storage array for storing the global value rank.

Moreover, the object of this invention is achieved by an information processing method characterized by having:

in each memory module of an information processing system having plural memory modules, each having a memory and a control device, and

a data transmission line that connects the memory modules and transmits a value of one memory module to another memory module,

the memory of each memory module being arranged to hold a value list,

a data transmitting step of transmitting a value contained in the value list to the other memory modules;

a data receiving step of receiving a value contained in the value list from the other memory modules; and

a rank judging step of deciding a global value rank in consideration of a value contained in the value lists of all the other memory modules, with reference to the value lists of the other memory modules received at the data receiving step, and storing the decided rank at a position corresponding to the value in the present memory module, in a global rank storage array for storing the global value rank.

### Advantage of the Invention

According to this invention, it is possible to provide an information processing apparatus that can realize significantly high-speed parallel processing by integrating processing and communication in the distributed memory type.

### BEST MODE FOR CARRYING OUT THE INVENTION

[Hardware Construction]

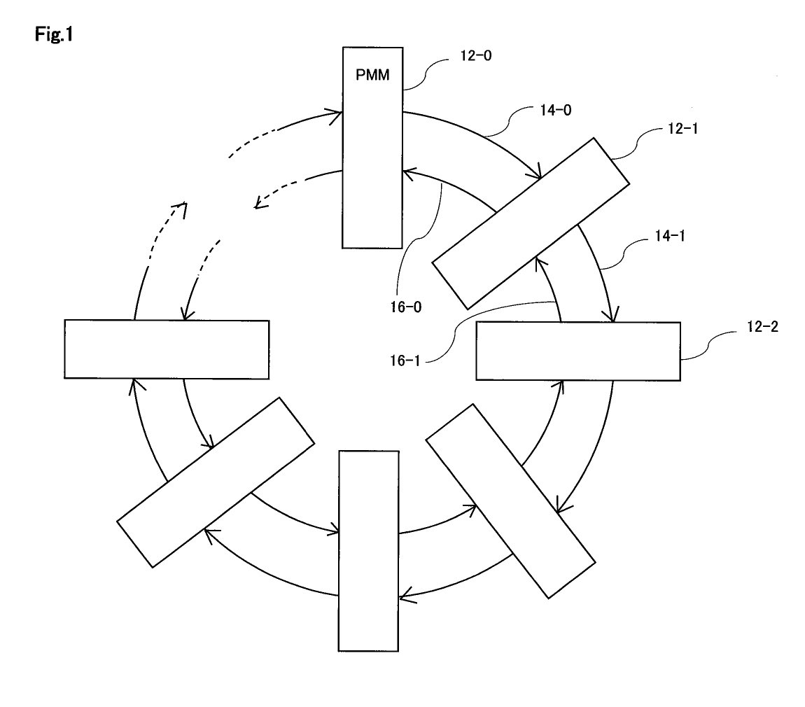

Hereinafter, an embodiment of this invention will be described with reference to the attached drawings. FIG. 1 is a block diagram schematically showing an information processing system according to an embodiment of this invention. As shown in FIG. 1, in this embodiment, plural processor memory modules (hereinafter referred to as “PMM”) 12-0, 12-1, 12-2, . . . are arranged in a ring shape, and the neighboring memory modules are connected by first buses that transmit data clockwise (for example, see reference numerals 14-0, 14-1) and second buses that transmit data counterclockwise (for example, see reference numerals 16-0, 16-1). On the first buses and the second buses, packet communication between PMMs is executed. In this embodiment, the transmission lines (packet transmission lines) on which this packet communication is executed are referred to as first buses and second buses.

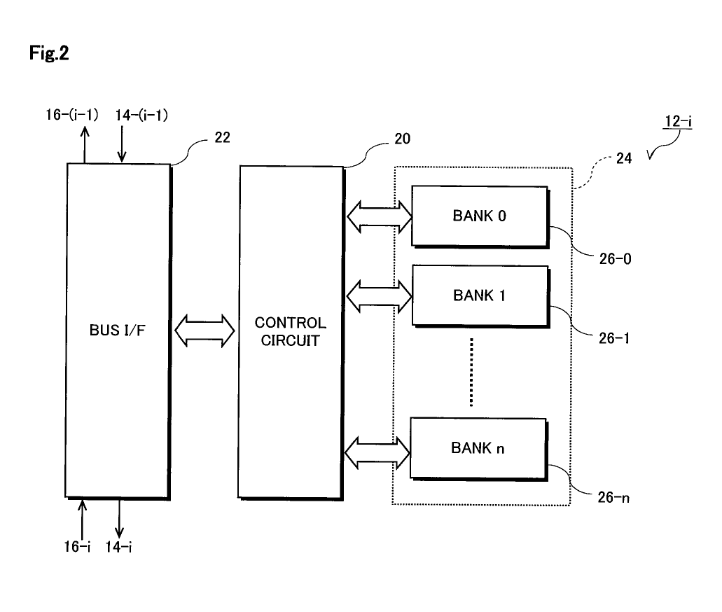

FIG. 2 is a view showing an exemplary structure of the PMM 12. As shown in FIG. 2, the PMM 12 has a control circuit 20 that controls access to a memory, execution of arithmetic operation and the like in accordance with commands, a bus interface (I/F) 22, and a memory 24.

The memory 24 has plural banks BANK0, 1, . . . , n (reference numerals 26-0, . . . , n). A predetermined array, which will be described later, can be stored in each bank.

The control circuit 20 can perform data transmission and reception with other external computers and the like. Also, the other computer may access a desired bank of the memory by bus arbitration.

[Data Storage Structure]

FIG. 3 is a view showing an example of spreadsheet data. In this manner, in spreadsheet data, values are given to various entries (in this example, “sex”, “age”, “height” and “weight”) for each record. In the information processing apparatus according to this embodiment, these spreadsheet data are held, in principle, on the basis of a data format as shown in FIG. 4.

As shown in FIG. 4, in an order set array OrdSet, a record number is arranged as a value for each order number. In this example, since all the records are expressed, the order numbers and the record numbers coincide with each other.

For example, with respect to sex, the spreadsheet data is expressed by a value list VL in which values of “male” or “female” as actual entry values are sorted in predetermined order, and a pointer array VNo to the value list in which the numbers in the value list indicated by the record numbers are stored corresponding to each of the elements (record numbers) in the order set array OrdSet. The combination of the value list VL and the pointer array VNo is also referred to as “information block” (the information block for sex corresponding to reference numeral 401).

As a value in the pointer array VNo that exists at the position indicated by an element (record number) in the order set array OrdSet is specified and an entry value in the value list VL that exists at the position indicated by the value is extracted, the entry value corresponding to the record number can be acquired. The similar structure is employed for the information blocks of the other entries.

If a single computer includes a single memory (physically, it may include plural memories, but it is referred to as single memory in terms of being arranged and accessed in a single address space), the order set array OrdSet, and the value list VL and pointer array VNo constituting each information block, may be stored in the memory. However, to hold a large amount of records, the memory capacity must increase according to that amount. Therefore, it is desirable that these records can be arranged distributively. It is also desirable that the distributed information can be distributively controlled and grasped, in view of realizing parallel processing.

Thus, in this embodiment, the plural PMMs distributively control and grasp the data of the records without duplication, and high-speed search, cross-totaling and search are realized by packet communication between PMMs.

[Compile Processing]

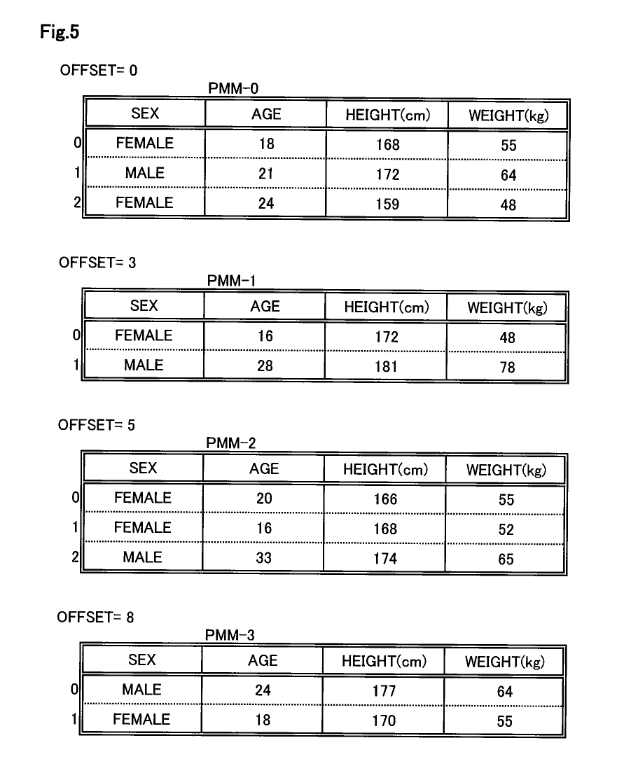

First, processing to distributively arrange data in the plural PMMs and enable use of these data (compile processing) will be described. For example, as shown in FIG. 5, it is assumed that data of a predetermined number of records are housed in four PMMs (PMM-0 to PMM-3). In this example, a sequence of data for record numbers 0 to 2, a sequence of data for record numbers 3 and 4, a sequence of data for record numbers 5 to 7, and a sequence of data for record numbers 8 and 9 are stored, respectively. In each PMM, the part of the spreadsheet data is stored in the form of information block.

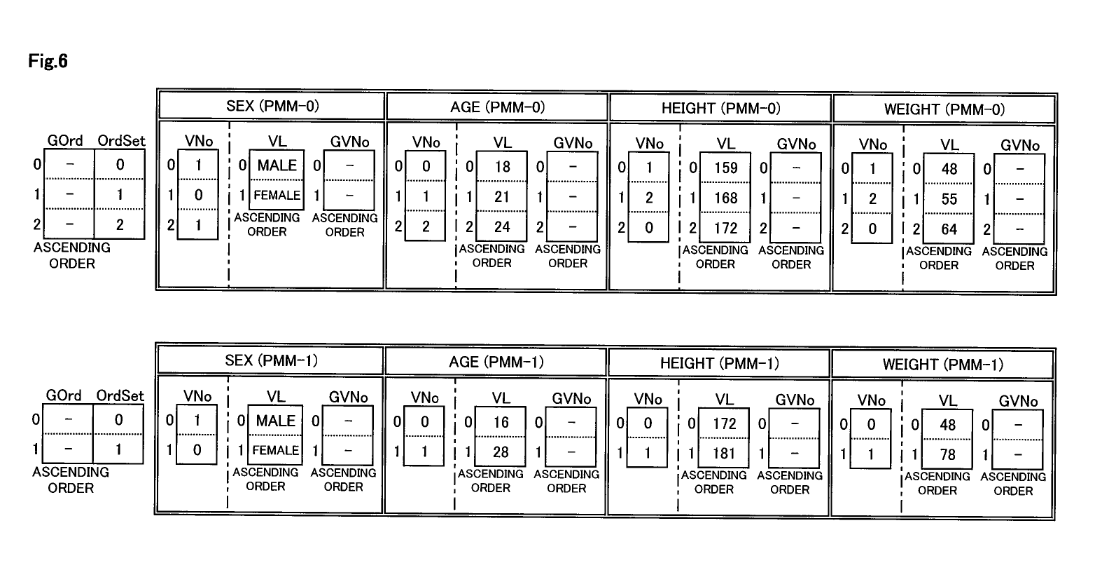

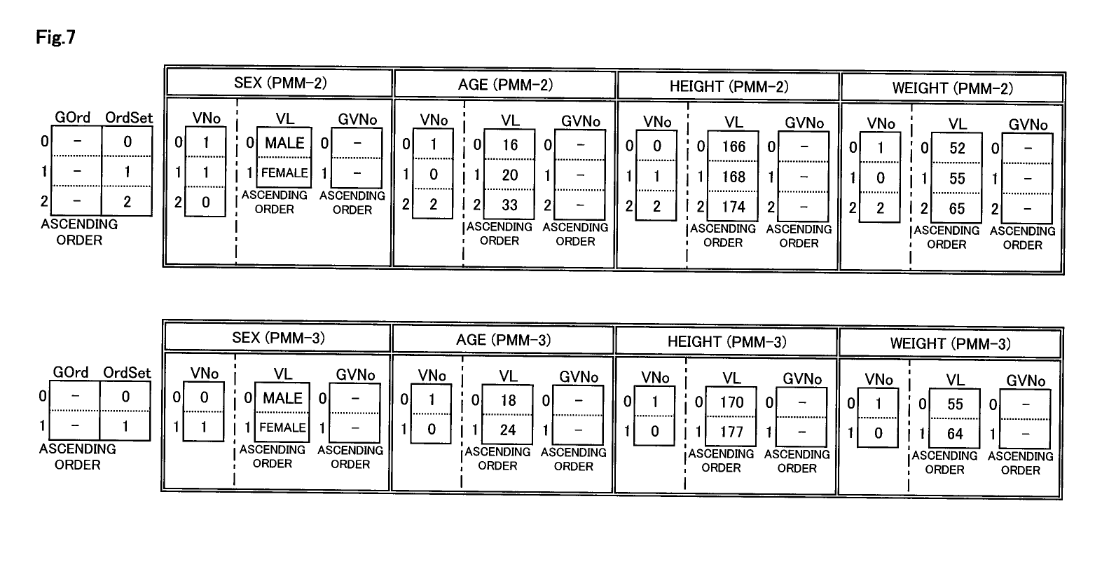

FIGS. 6 and 7 are views showing an example of spreadsheet data that are initially controlled distributively in the PMMs-0 to PMMs-4. As seen from these figures, a subset or the like of information blocks for each entry is housed in each PMM. For example, in FIG. 6, in an information block 601 for the entry “sex”, a subset VNo (this, too, is referred to as “pointer array”) of the original pointer array VNo (see FIG. 4) and a subset VL (this, too, is referred to as “value list”) of the original value list VL (see FIG. 4) are included.

The number of elements of the pointer array VNo coincides with the number of records that are distributively controlled by the PMM. On the other hand, for the value list VL, only the values indicated by the pointer array VNo are extracted. With respect to the entry “sex”, since the values of the pointer array VNo indicate all the elements (entry values) of the value list VL, the value list VL and the original value list VL coincide with each other. Meanwhile, it can be understood that, with respect to the entries “age”, “height” and “weight”, only the values indicated by the elements in the pointer array are extracted from the original value list VL, as a subset of the original value list VL.

Moreover, in the distributively controlled information block, the elements of the value list are converted from the elements of the corresponding original pointer array VNo in each PMM so that the elements (entry values) of the value list VL are indicated properly by the elements of the pointer array VNo, that is, consistency is maintained in the local processing (designation of a pointer value or designation of an entry value) within the PMM.

As described above, in the distributively controlled information block, only the elements (entry values) necessary in the distributively controlled information block are held in the value list VL. Therefore, consistency in the local processing is maintained by the pointer array VNo and the value list VL. However, in order to maintain consistency in the processing between PMMs, it is necessary to grasp the positioning in the entire value list, of the elements (entry values) of the value list VL controlled distributively in each PMM, that is, what order of position each entry value is situated in the entire value list in accordance with predetermined order. Thus, in this embodiment, in each distributively controlled information block, a global value number array GVNo is arranged to enable housing of numbers indicating the value positions corresponding to the entry values.

An offset value (OFFSET) for controlling the subset of the information block is allocated to each PMM. This offset value OFFSET corresponds to the leading value in the original order set OrdSet related to the records that are distributively controlled in the PMM.

Also, in each PMM, a new order set OrdSet is created to maintain consistency in the local processing. The number of elements of the order set OrdSet coincides with the number of records controlled in a distributed manner in the PMM. On the other hand, in order to maintain consistency in the processing between PMMs, it is necessary to grasp what numbers in the entirety (elements in the order set) the records controlled in a distributed manner in each PMM have. Therefore, a global order set array GOrd housing each record's number in the entirety is provided.

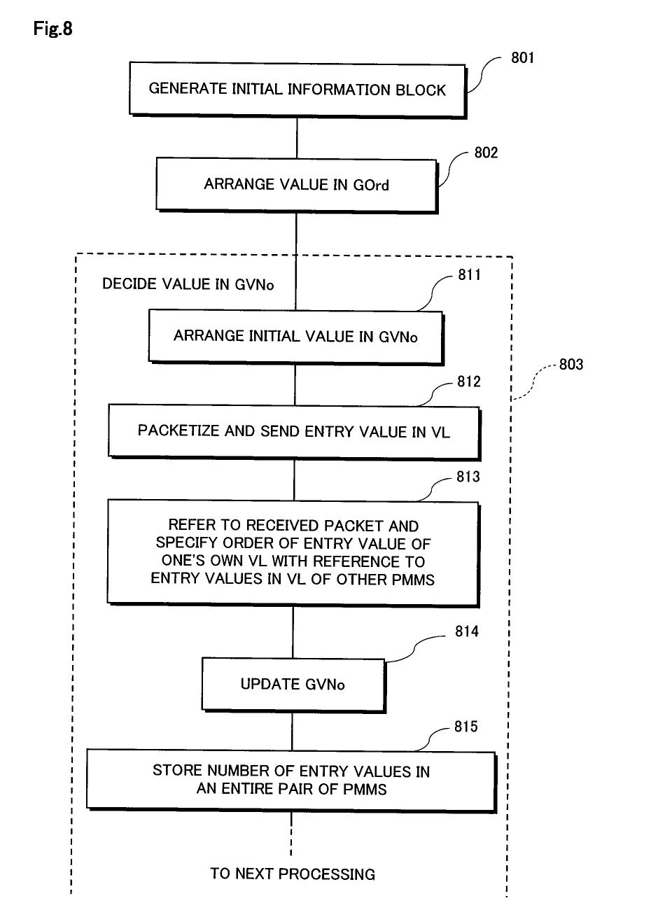

FIG. 8 is a flowchart schematically showing the compile processing according to this embodiment. As shown in FIG. 8, first, an initial information block as shown in FIGS. 6 and 7 is generated in each PMM (step 801). This can be realized, for example, by providing the order set OrdSet, the pointer array VNo, value list VL constituting each information block, and offset value OFFSET that should be distributively controlled, to the PMM from external other computers. These arrays are stored into the memory 24 within each PMM.

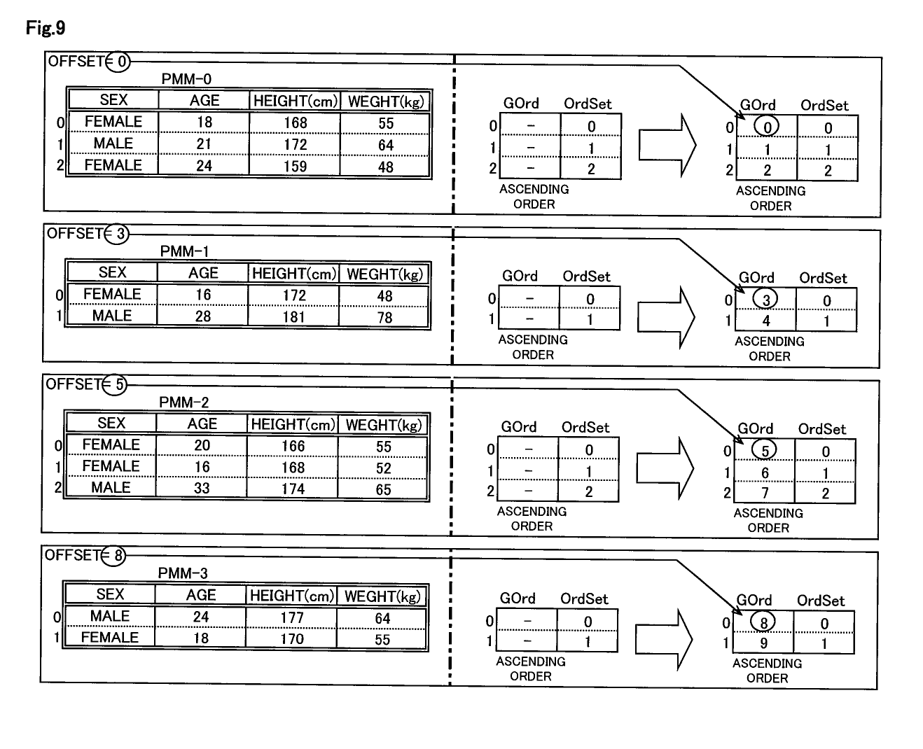

Step 802 and the subsequent steps shift to the local processing in each PMM and the processing related to packet communication between PMMs. The control circuit 20 of each PMM calculates each value to be arranged in the global order set array GOrd with reference to the offset value and arranges the values in the array (step 802). FIG. 9 is a view showing the arrangement of values into the global order set array GOrd in the example shown in FIGS. 6 and 7. Here, the values of the order set with the offset value OFFSET added thereto may be arranged at positions corresponding to the global order set array GOrd. Step 802 can be realized by the local processing in each PMM.

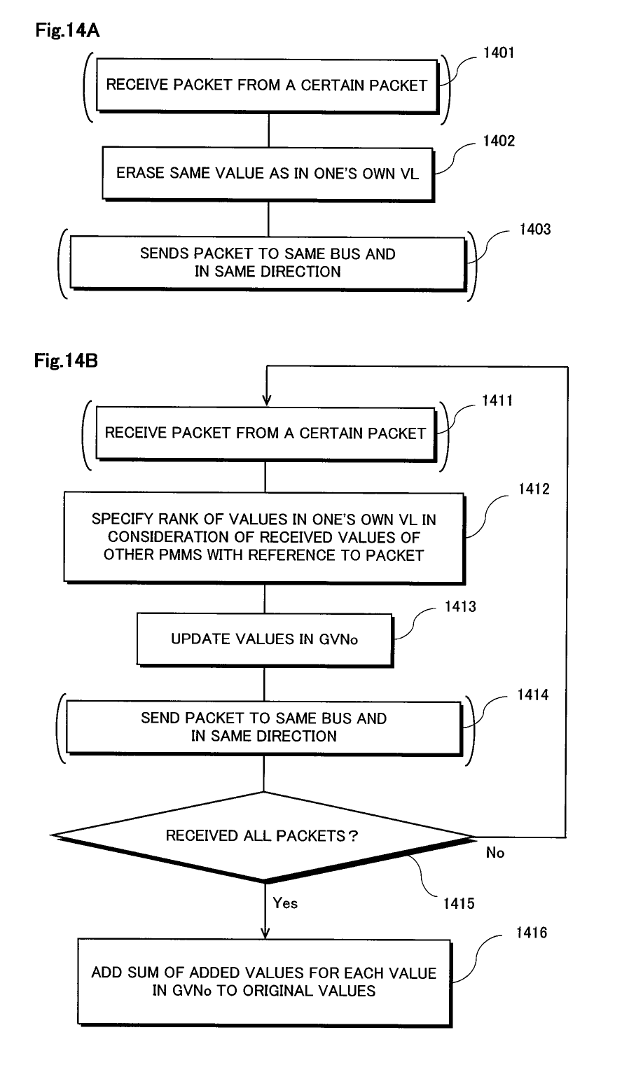

Next, the value in a global value list number array GVNo is decided (step 803). The decision of the value in this global value list number array GVNo will be described in detail hereinafter. In the following, it is assumed that the clockwise buses 14 have transmission line of four channels, and that the counterclockwise buses 16 similarly have transmission lines of four channels. Hereinafter, the clockwise buses of the respective channels are referred to as U-0 to U-3 and the counterclockwise buses of the respective channels are referred to as D-0 to D-3. Basically, as a PMM receives a packet from a bus (step 1401) as shown in FIG. 14A, the PMM erases the same value as the value in its own VL from the value in VL in the packet, and sends the packet after the erasure of the value, on the same bus and in the same direction as the bus from which the packet was sent thereto (step 1403). The processing in each PMM will be described further in detail.

(First Timing)

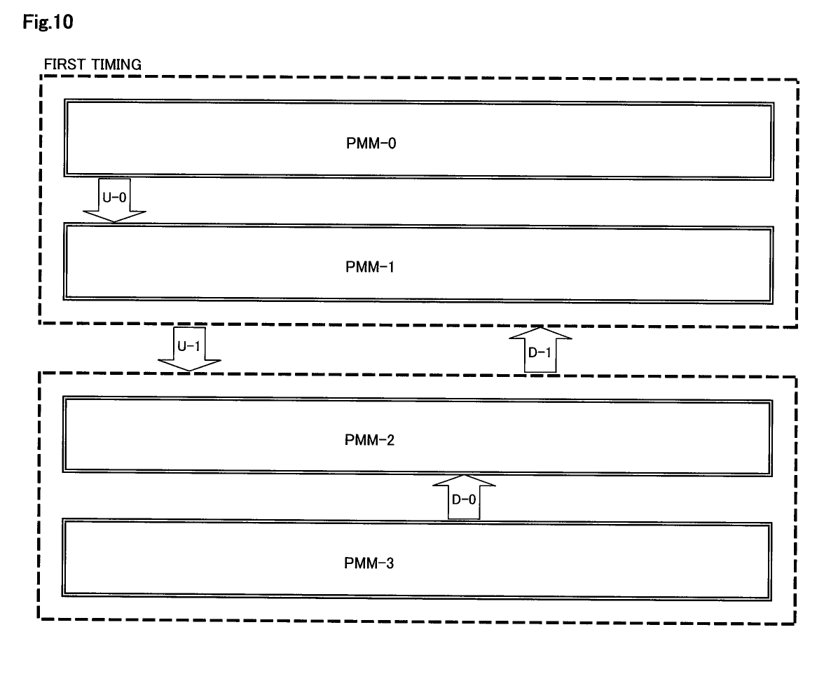

As shown in FIG. 10, at the first timing, PMM-0 sends out a packet containing a list of values in PMM-0's own VL to the bus U-0 (see reference numeral 1001). PMM-1 sends out a packet containing a list of values in PMM-1's own VL to the bus U-1 (see reference numeral 1002). Similarly, PMM-2 and PMM-3 send out a packet containing a list of values of their own VL to the bus D-1 and D-0 (see reference numerals 1003 and 1004). In this example, U-0 and U-1 are used for transmitting the packets containing the values in VL of PMM-0 and PMM-1, respectively, and U-2 and U-3 are not used. D-0 and D-1 are used for transmitting the packets containing the values in VL of PMM-3 and PMM-2, respectively, and D-2 and D-3 are not used.

(Second Timing)

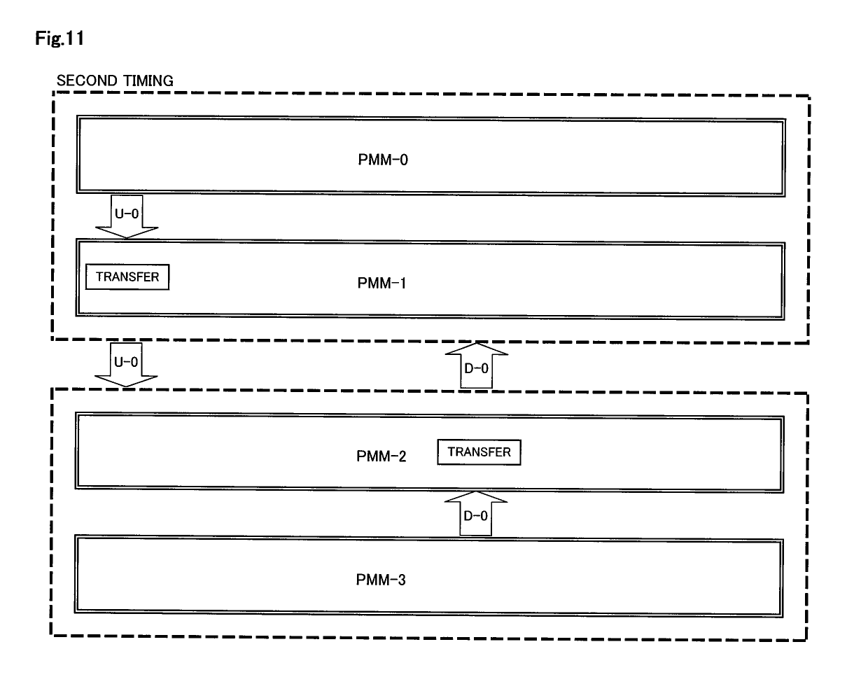

The PMM that has received a packet transfers the packet as the next packet in the same direction. Prior to this, if the existence the same value as the value in VL held by the PMM itself is found by referring to the values of the received packet, the packet is transferred after this value is erased. As shown in FIG. 11, in this example, for PMM-1, if the same value as the value in PMM-1's own VL is found by referring to the packet transmitted via the bus U-0 from PMM-0, PMM-1 erases this value and then transfers the packet to PMM-2 via the bus U-0. Similarly, for PMM-2, if the same value as in PMM-2's own VL is found by referring to the packet transmitted via the bus D-0 from PMM-3, PMM-2 erases this value and then transfers the packet to PMM-1 via the bus D-0.

(Third Timing)

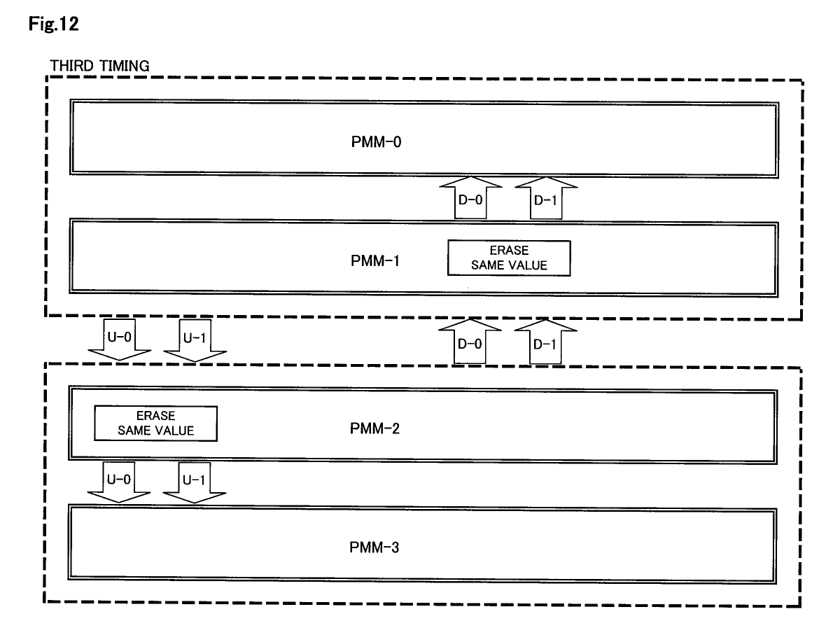

Moreover, the PMM that has received a packet erases the same value as in its own VL with reference to the values in VL of the received packet, and transfers it as the next packet in the same direction. In FIG. 12, for PMM-1, if the same value as the value in PMM-1's own VL is found by referring to the values in VL of the packets transmitted via the buses D-0 and D-1 from PMM-2, PMM-1 erases this value and then transfers the respective packets to PMM-2 via the buses D-0 and D-1. For PMM-2, if the same value as the value in PMM-2's own VL is found by referring to the values in VL of the respective packets transmitted via the buses U-0 and U-1 from PMM-1, PMM-2 erases this value and then transfers the respective packets to PMM-3 via the buses U-0 and U-1.

(Fourth Timing)

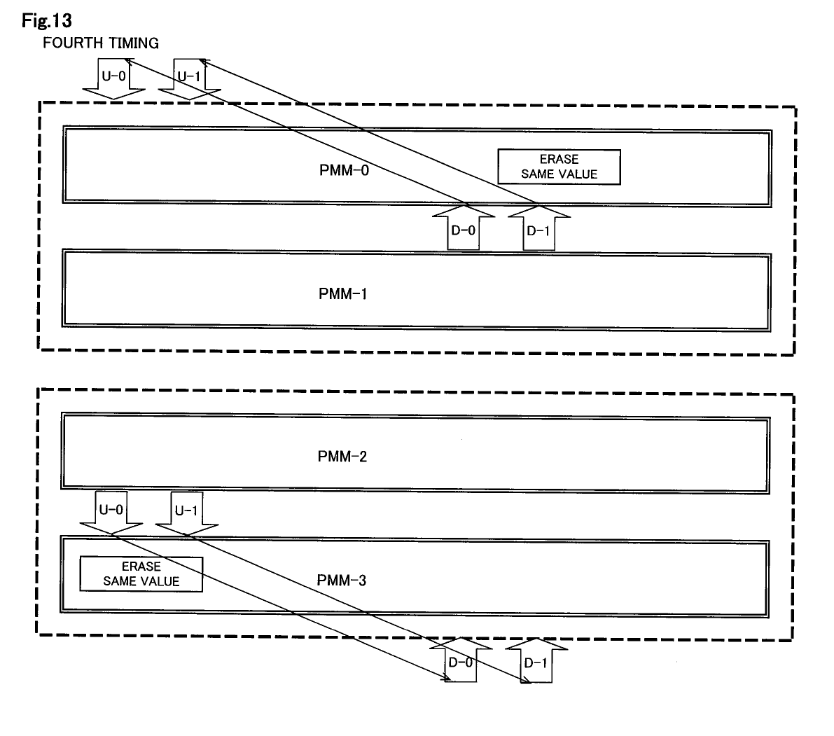

Also at the next timing, the PMM that has received a packet erases the same value as in its own VL with reference to the value in VL of the received packet. For example, in the example of FIG. 13, for PMM-0, if the same value as the value in PMM-0's own VL is found by referring to the values in VL of the respective packets transmitted via the buses D-0 and D-1, PMM-0 erases the value in VL of the respective packets. Similarly, for PMM-3, if the same value as the value in PMM-3's own VL is found by referring to the values in VL of the packets transmitted via the buses U-0 and U-1, PMM-3 erases the value in VL of the respective packets.

In the examples shown in FIGS. 10 to 13, at the stage shown in FIG. 13, the values in VL of each PMM have gone through all the other PMMs and the same value in the other PMMs (that is, duplex value) has been deleted. If four or more PMMs are used, deletion of the same value and transfer are repeated further.

Hereinafter, the erasure of the value in VL at the first to fourth timings will be described again, paying attention to the packets transmitted via U-0 and U-1.

First timing

U-0: all the values in VL of PMM-0

U-1: all the values in VL of PMM-1

Second timing

U-0: (all the values in VL of PMM-0)
(value existing in duplicate in PMM-1)
   U-1: all the values in VL of PMM-1

Third timing

U-0: (all the values in VL of PMM-0)
(value existing in duplicate in PMM-1)
(value existing in duplicate in PMM-2)
   U-1: (all the values in VL of PMM-1)
(value existing in duplicate in PMM-2)

Fourth timing
U-0: (all the values in VL of PMM-0)
(value existing in duplicate in PMM-1)
(value existing in duplicate in PMM-2)
(value existing in duplicate in PMM-3)

U-1: (all the values in VL of PMM-1)
(value existing in duplicate in PMM-2)
(value existing in duplicate in PMM-3)

Therefore, when the fourth timing is finished, the sum of values in the packets from the buses U-0 and U-1 held in PMM-3 (expressed as sum: “U-0+U-1”) contains the following values.
U-0+U-1: (all the values in VL of PMM-0 and PMM-1 that are not in duplicate)−(value existing in duplicate in PMM-2 or PMM-3)

Therefore, in PMM-2 and PMM-3, it is possible to correctly order the values in their respective VL in each PMM (that is, in consideration of the order in the other PMMs) by referring to “U-0+U-1”.

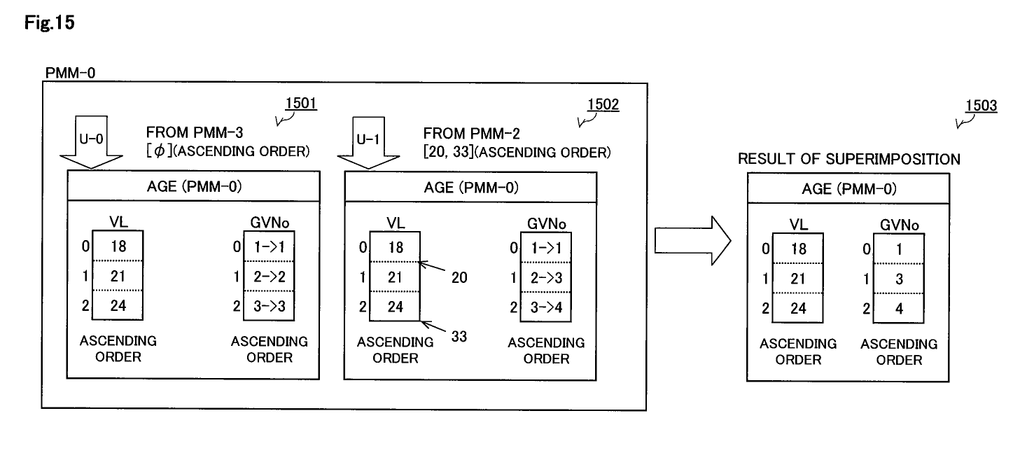

This ordering will be described hereinafter. PMM-0 updates the values in its own GVNo with reference to the values in VL contained in the received packet from the bus D-0. Since PMM-0 already holds a packet containing VL, reception of a packet from a certain bus (step 1411) shown in FIG. 14B is omitted. For example, PMM-0 refers to the values in VL of the packet provided via D-0 (that is, the values in PMM-3's VL: in this example, [φ]) and decides the rank of the values in its own VL (step 1412) and the values in the global value number array GVNo (step 1413), in consideration of those values. Since the above-described values in VL of the packet provided via D-0 are [φ], the values in GVNo do not change (see reference numeral 1501 in FIG. 15). This packet is sent to PMM-1 via U-0 (step 1414).

Also, PMM-0 refers to the values in VL of the packet provided via D-1 (that is, the values in PMM-2's VL: here [20, 33]), and decides the rank of the values in its own VL (step 1412) and the values in the global value number array GVNo (step 1413, see reference numeral 1502 in FIG. 15), in consideration of those values. This packet is sent to PMM-1 via U-1 (step 1414). In PMM-0, the packets received via D-0 and D-1 are sent toward U-0 and U-1, respectively. Subsequently, the packets are sent via U-0 and U-1.

When reference to the values in VL of the required packets is completed in this manner, the results of update of GVNo based on the values in VL of the respective packets are superimposed (step 1416). More specifically, the sum of added values of each value in GVNO may be added to the original values in GVNo. As indicated by reference numeral 1501 in FIG. 15, GVNo updated with reference to the values in PMM-3's VL has [1, 2, 3] and GVNO updated with reference to the values in PMM-2's VL have [1, 3, 4]. Therefore, as a result of superimposition, the ultimate values in GVNO are [1, 3, 4] (see reference numeral 1503 in FIG. 15).

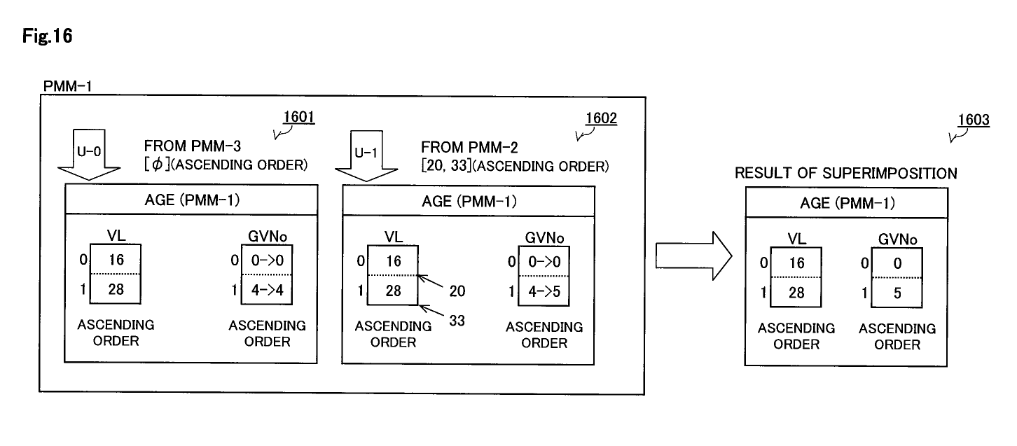

Similarly, PMM-1, having received a packet from PMM-0, executes similar processing and updates the values in GVNo with reference to each of the received packets (see reference numerals 1601 and 1602 in FIG. 16). Again, GVNo updated with reference to the values in VL of the packet received via U-0 (that is, the values in PMM-3's VL) has [0, 4], and GVNo updated with reference to the values in VL of the packet received via U-1 (that is, the values in PMM-2's VL) has [0, 5]. Therefore, as a result of superimposition, the ultimate values in GVNo are [0, 5] (see reference numeral 1603 in FIG. 16).

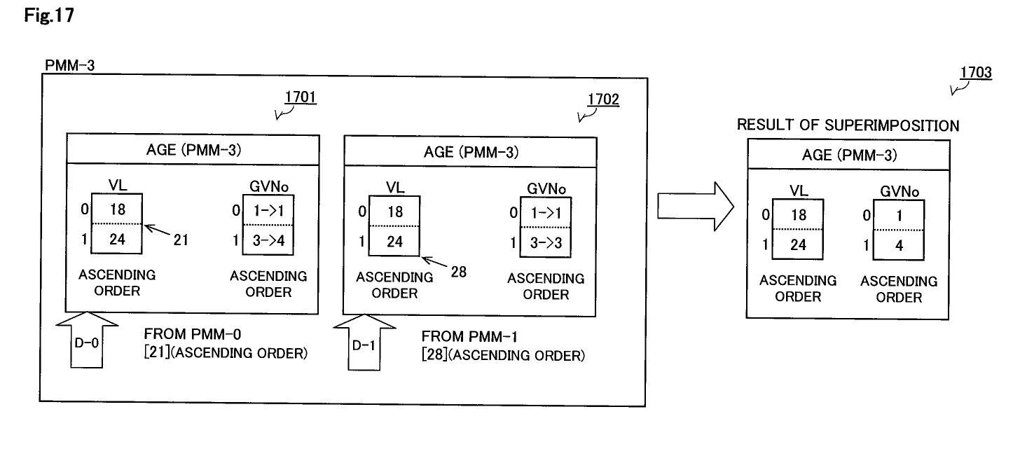

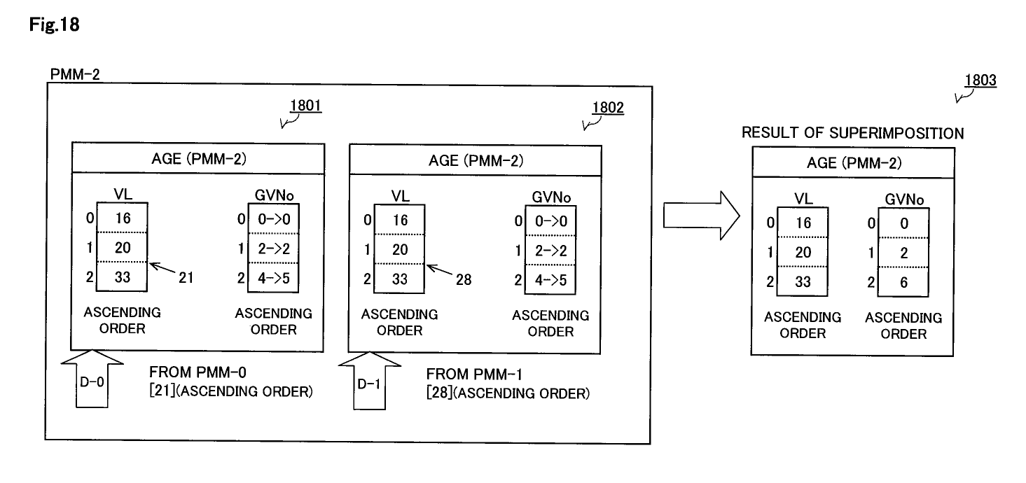

Meanwhile, PMM-3 has received packets from U-0 and U-1. The values in VL of the packet received via U-0 are based on the values in PMM-0's VL, and the values in VL of the packet received via U-1 are based on the values in PMM-1's VL. PMM-3, too, executes the processing as shown in FIG. 14B to update the values in GVNo, and superimposes the results of update to acquire the ultimate values in GVNo (see reference numerals 1701 to 1703 in FIG. 17). After that, PMM-3 sends the packet based on the values in PMM-0's VL to PMM-2 via D-0 and sends the packet based on the values in PMM-1's VL to PMM-2 via D-1 (see reference numerals 1801 to 1803 in FIG. 18).

As the global order set array GOrd and the global value number array GVNo are provided in this manner, the compile processing ends. As the compile processing ends, processing such as search, cross-totaling and sorting can be executed smoothly and quickly.

[Search Processing]

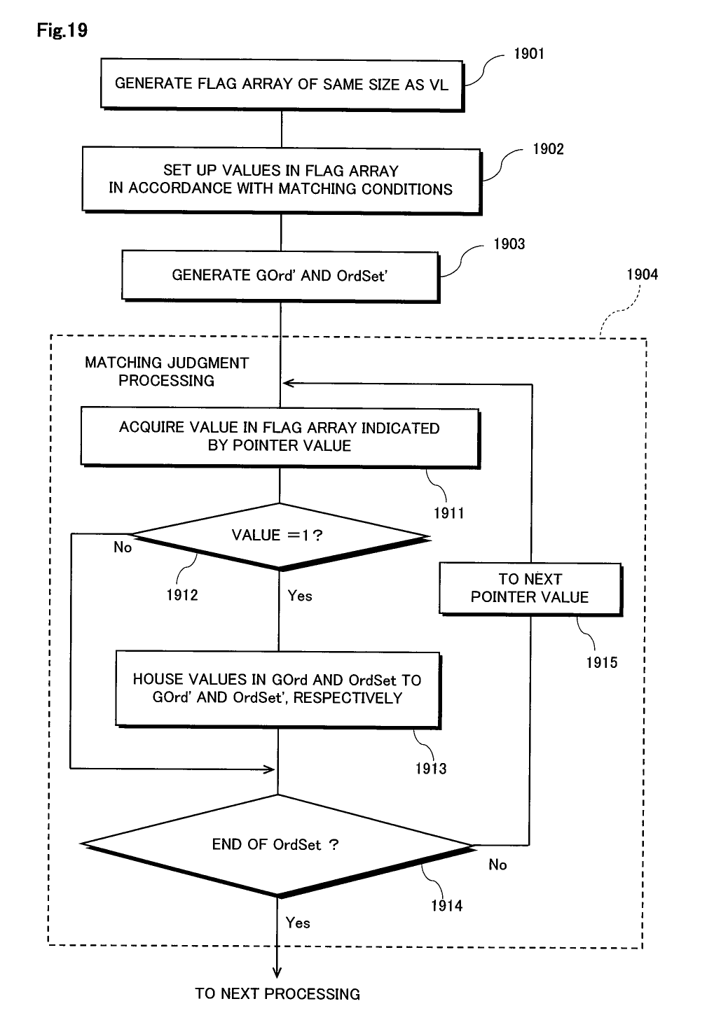

Next, search processing will be described. As shown in FIG. 19, first, each PMM creates a flag array of the same size as the value list VL with respect to an entry as a subject of search (step 1901). Next, the values in the flag array are set up in accordance with matching conditions (step 1902). In this setup, “1” is set as a value in the flag array corresponding to an entry value that meets the search condition, and “0” is set as the other values in the flag array.

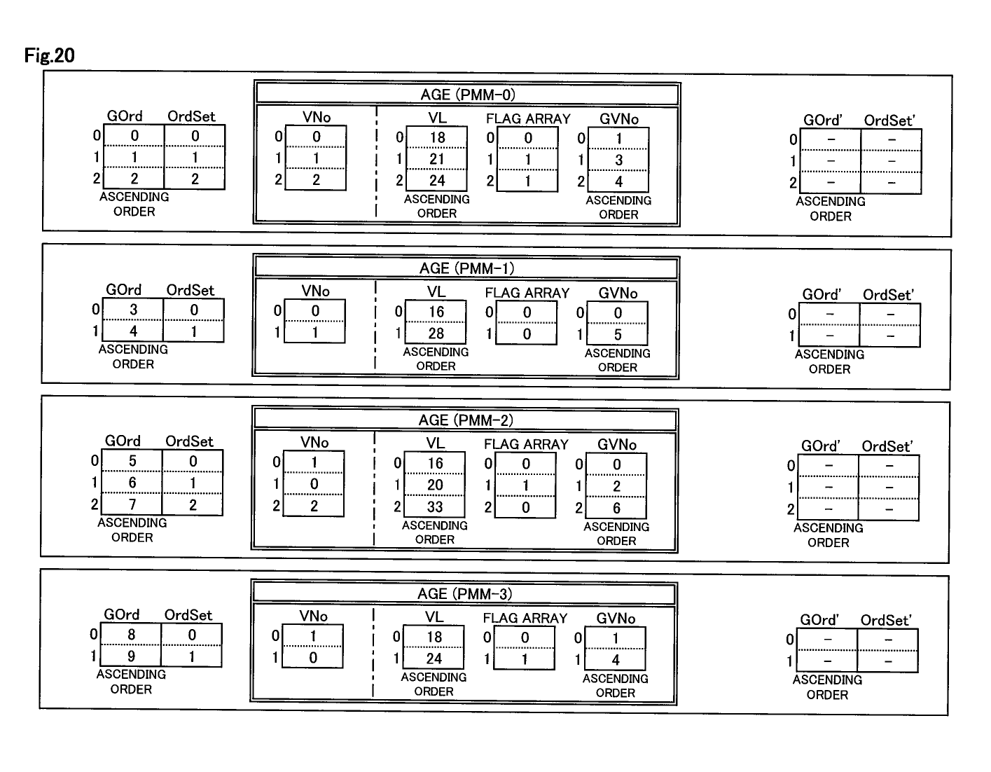

Next, each PMM generates new global order set arrays GOrd′ and OrdSet′, which are search result storage areas (step 1903). FIG. 20 is a view showing an example of state where new global order set array and order set array are generated as flag array and area in which values are set up, in each PMM. In this example, with respect to the entry “age”, records of “20 years old or older and 24 years old or younger” are searched. Therefore, in each PMM, the values in the flag array corresponding to the entry value of 20 or larger and 24 or smaller are “1”.

Next, judgment of matching is executed (step 1904). In this processing, a value of pointer VNo (pointer value) to the value list is found for each value in the order set array OrdSet, and the value in the flag array indicated by the pointer value is acquired (step 1911). If this value is “0” (No at step 1912), no processing is executed. On the other hand, if the value in the flag array is “1” (Yes at step 1912), the values in the global order set array GOrd and the order set array OrdSet related to the processing are sequentially housed into the new global order set array GOrd′ and order set array OrdSet′ (step 1913).

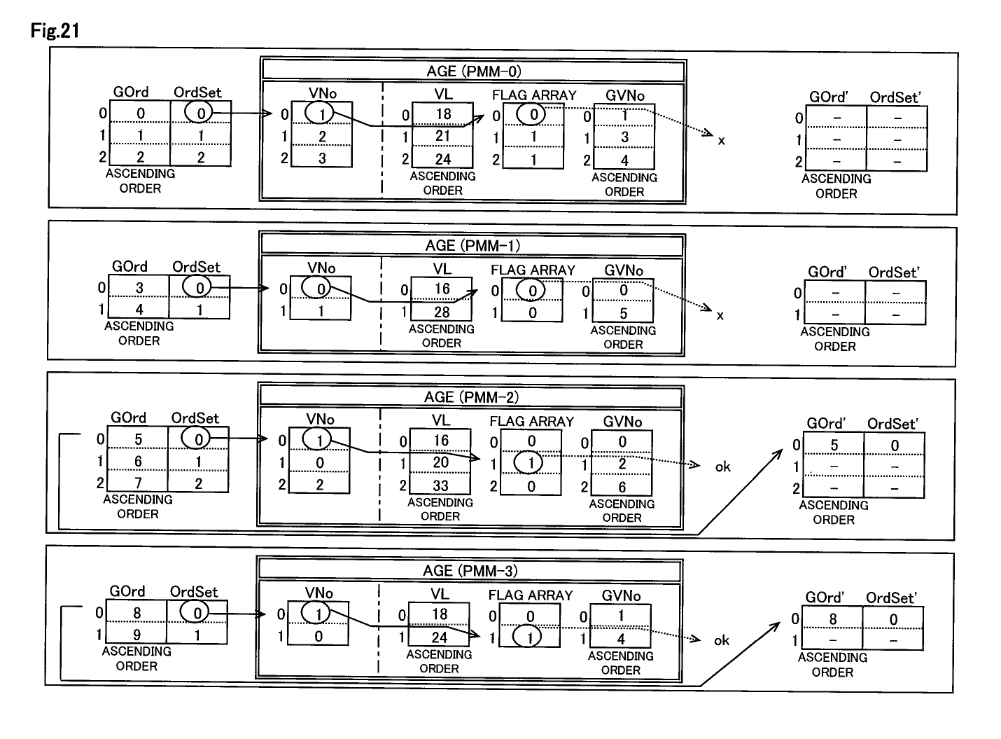

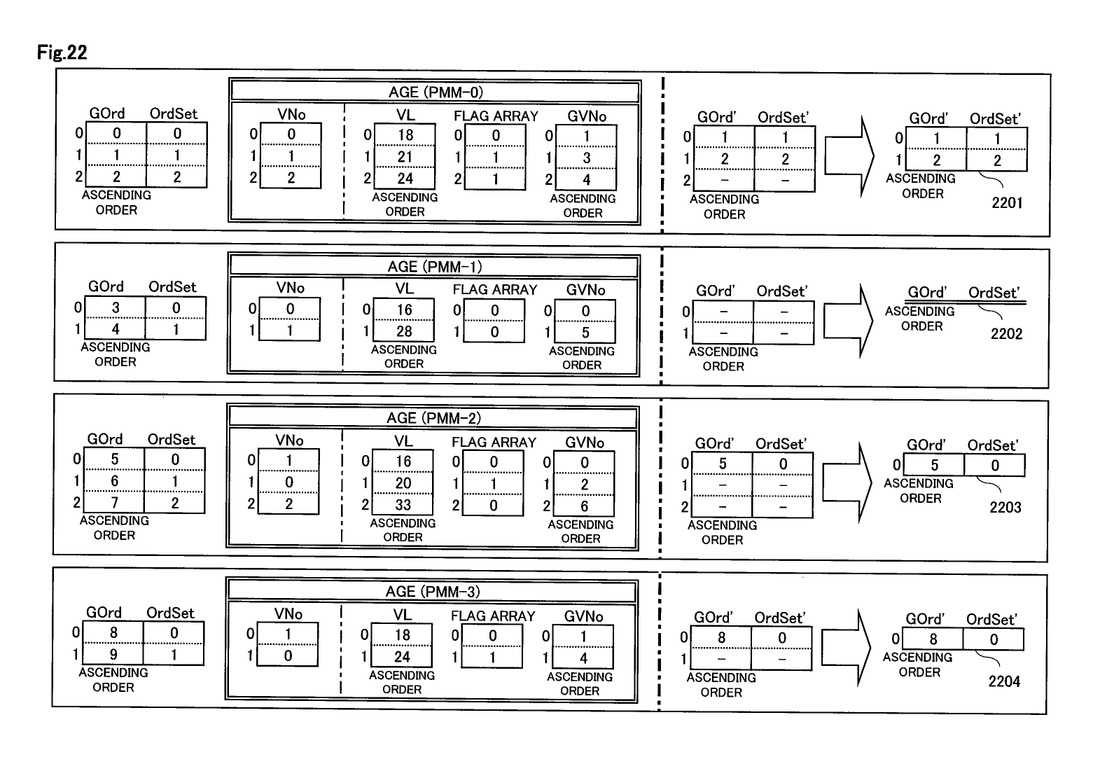

The processing of steps 1911 to 1913 is repeated to the last element in the order set array (see steps 1914 and 1915). The processing of FIG. 19 is executed locally and in parallel in each PMM. FIG. 21 shows an example of state where the processing of FIG. 19 is executed and values are arranged locally and in parallel in the new global order set array GOrd′ and order set array OrdSet′ in each PMM. FIG. 22 shows a state where unnecessary areas are deleted from the arrays (see reference numerals 2201 to 2204).

After the above-described processing, the processing shifts to processing for packet communication between PMMs. In this embodiment, it is assumed that buses of four channels (packet transmission lines) exist clockwise as shown in FIG. 1 and that four buses (packet transmission lines) also exist counterclockwise. The clockwise buses are referred to as U-0 to U-3 and the counterclockwise buses are referred to as D-0 to D-3.

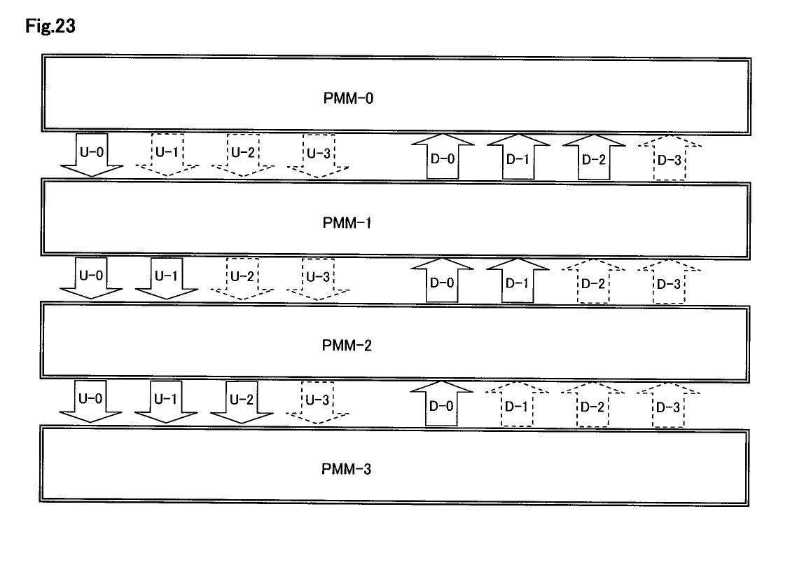

As shown in FIG. 23, the buses U-0, U-1 and U-2 transmit the global order set arrays GOrd′ of PMM-0, PMM-1 and PMM-2. The buses D-0, D-1 and D-2 transmit the global order set arrays GOrd′ of PMM-3, PMM-2 and PMM-1 in the direction opposite to the buses U-0 to U-2.

For example, PMM-0 uses U-0 to send a packet containing its own GOrd′ and receives packets containing GOrd′ of PMM-3 to PMM-0 from D-0 to D-2. PMM-1 uses U-1 and D-2 to send a packet containing its own GOrd′ and receives packets containing GOrd′ of PMM-0, PMM-3 and PMM-2 from U-0, D-0 and D-1.

PMM-2 uses U-2 and D-1 to send a packet containing its own GOrd′ and receives packets containing GOrd′ of PMM-0, PMM-1 and PMM-3 from U-0, U-1 and D-0. PMM-3 uses D-0 to send a packet containing its own GOrd′ and receives packets containing GOrd′ of PMM-0 to PMM-2 from U-0 to U-2.

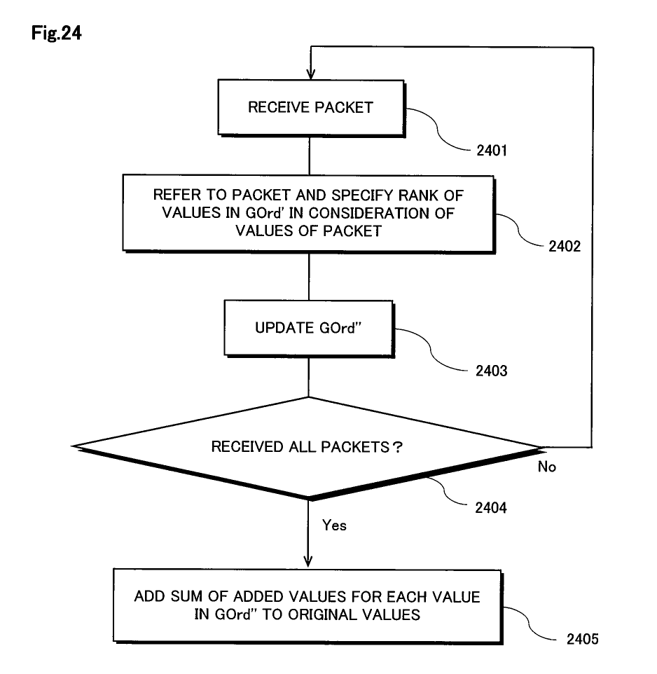

The processing in each PMM will be described hereinafter. As shown in FIG. 24, when a packet is received from one of the buses (step 2401), the PMM refers to the values in GOrd′ of the packet and specifies the rank of the values in its own GOrd′ in consideration of those values (step 2402). The values corresponding to the rank are housed in a new global order set array GOrd″ (step 2403). The PMM executes similar processing with respect to all the received packets (see step 2404). Therefore, GOrd″ is generated by the number of received packets.

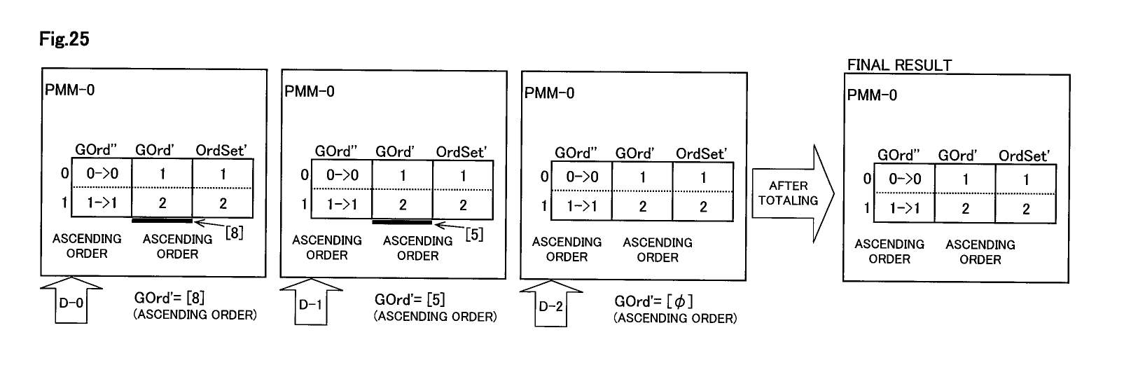

FIGS. 25 to 28 show examples in which values in a new global order set array GOrd″ are generated in PMM-0 to PMM-2. In each of these figures, the third block from left represents the newly generated Gord″.

If all the packets have been received, the PMM calculates the sum of added values to each value in each GOrd″ and adds the calculated sum to the original values in GOrd″ (step 2405). The array formed by the result of this addition is the global order set array that should be provided ultimately. The right end block in each of FIGS. 25 to 28 is equivalent to the global order set array in which GOrd″ has been found.

The value addition processing (step 2405) need not be carried out after the reception of all the packets. Every time a packet is received and a new global order set array GOrd″ is generated, the added values to GOrd″ may be added to the original values.

As such processing is executed in parallel in the respective PMMs, the values in the global order set array GOrd″ of the PMMs are determined. The values in the array GOrd″ represent the ranks in the entirety, that is, global ranks, of the records extracted by search. If GOrd″ is used as new GOrd and the records are sequentially taken out in accordance with the values in the array GOrd, it is possible to acquire the result of search according to predetermined order.

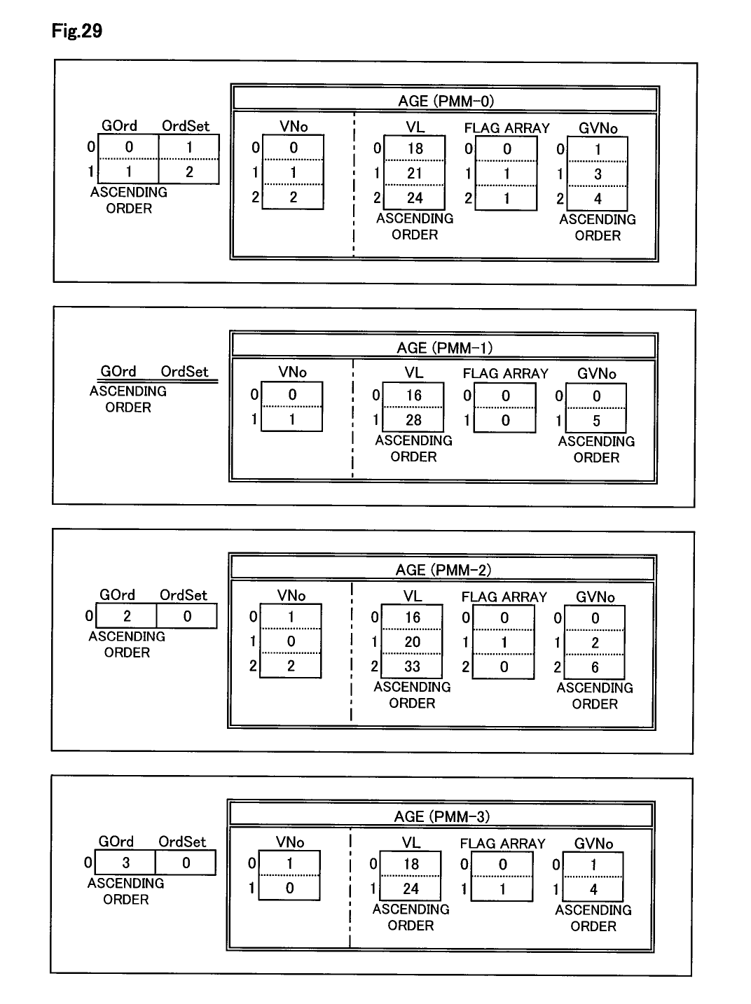

The array GOrd of each PMM in FIG. 29 is a new array acquired as a result of search processing. If the values in the corresponding array OrdSet and the values in the value list VL indicated by these values are taken out in order from smaller values in the array GOrd, the records of “20 years old or older and 24 years old or younger” for the entry of “age” can be listed in order of record number (order set).

[Sorting Processing]

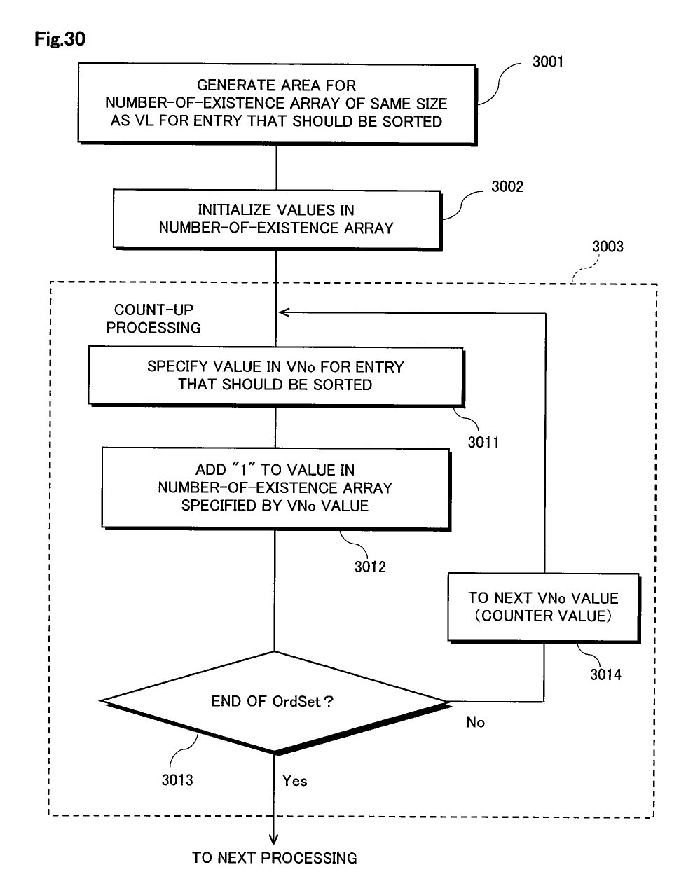

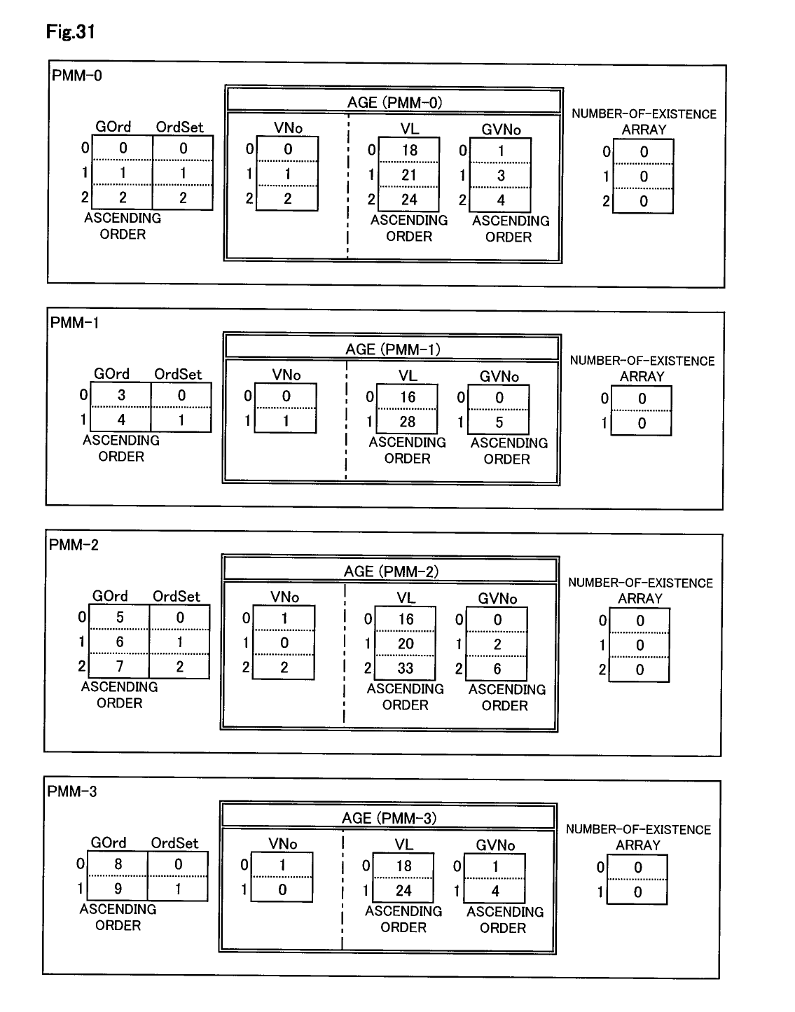

Next, sorting processing will be described. Again, the processing is started in the state where the compile processing has been finished. As shown in FIG. 30, each PMM generates an area for a number-of-existence array of the same size as the value list VL for the entry that should be sorted (step 3001), and gives an initial value “0” as each value in the area (step 3002). FIG. 31 shows a state where an area having the same size as the value list VL has been created in each PMM with respect to the entry of “age”, with an initial value “0” given as each value.

Next, each PMM executes count-up processing to each of the number-of-existence arrays (step 3003). More specifically, each PMM specifies the values in the pointer array VNo for the entry that should be sorted, with reference to the values in the order set array OrdSet (step 3011). Next, each PMM increases the values at the positions indicated by the values in the pointer array VNo, in the number-of-existence array (step 3012). Such processing is repeated to the end of the order set array OrdSet (see steps 3013 and 3014).

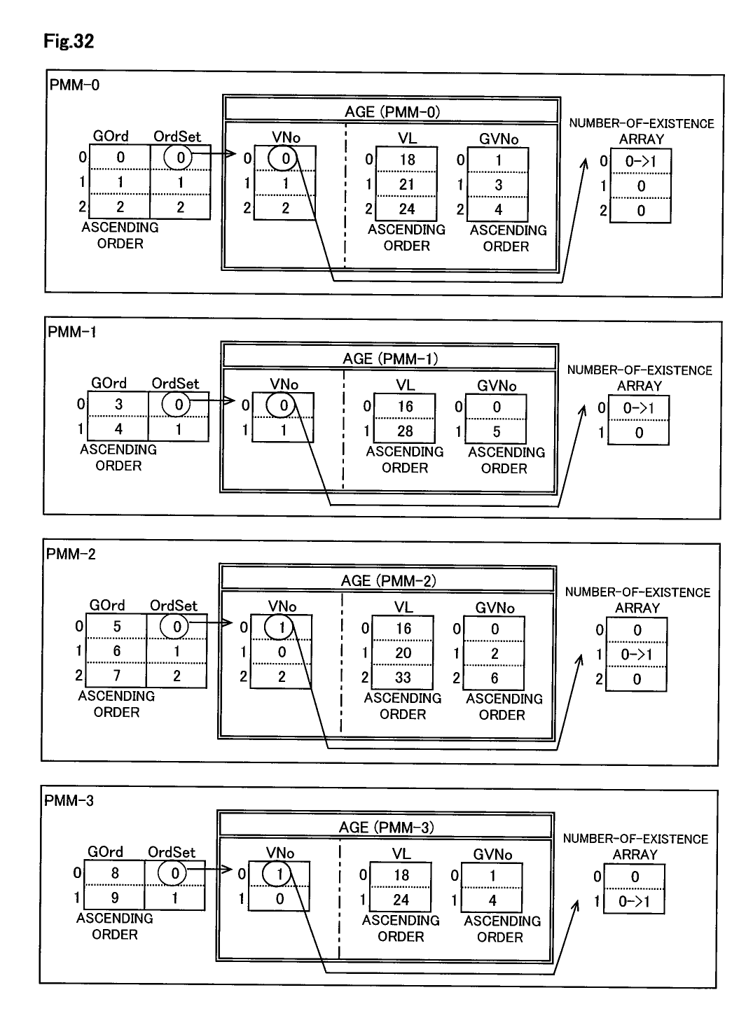

FIG. 32 is a view showing an example of the count-up processing in each PMM. For example, in PMM-0, the value in the pointer array VNo for age, corresponding to the position indicated by an element “0” of the order set array OrdSet, is “0”. Therefore, the value situated at the “0^{th}” position in the number-of-existence array, that is, at the leading position, is increased from “0” to “1”. It can be understood that similar processing is also executed in the other PMMs.

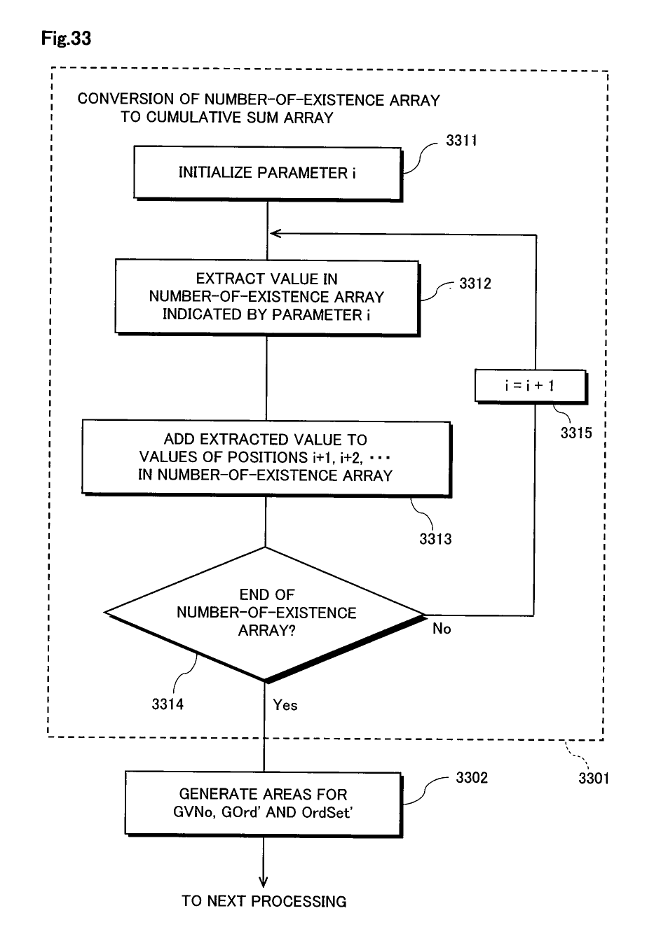

When the count-up processing is finished, each PMM calculates the cumulative sum of the elements of the number-of-existence array and converts the number-of-existence array to a cumulative sum array, as shown in FIG. 33 (step 3301). The cumulative sum, which is an element of the cumulative sum array, indicates the leading position of the record indicating the entry value of the position where the cumulative sum is arranged, in consideration of the number of existence indicating the number of records that indicate the entry values. Specifically, each PMM initializes a parameter “i” indicating the position in the array (step 3311) and extracts the value in the number-of-existence array indicated by the parameter (step 3312). The value extracted at step 3312 is added to the values in the number-of-existence array that are situated at the positions following the position indicated by the parameter “i”, that is, “i+1”, “i+2”, . . . (step 3313). The processing shown in steps 3312 and 3313 can be repeated by the number of elements (entry values) in the value list VL (see steps 3314 and 3315).

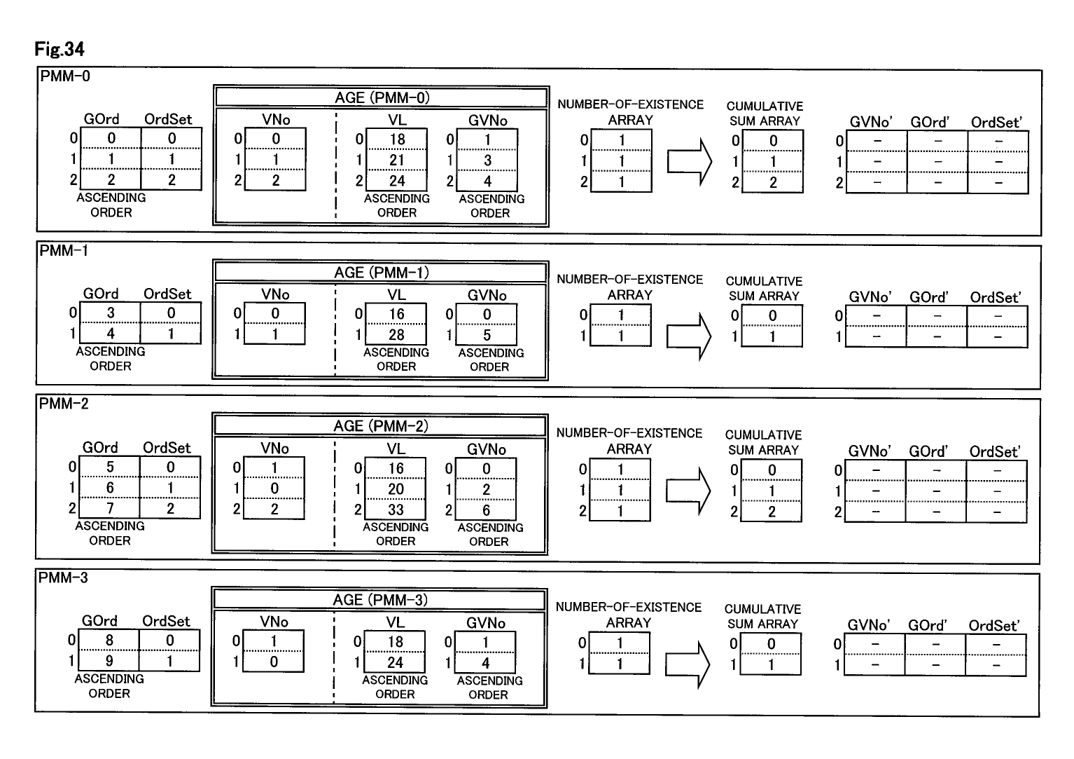

In this manner, for example, a cumulative sum array as shown in FIG. 34 can be acquired. Moreover, each PMM also creates areas for the arrays GVNo, GOrd′ and OrdSet′ for later storing the ranks in the entire PMMs (step 3302). The sizes of these arrays coincide with the size of the value list VL.

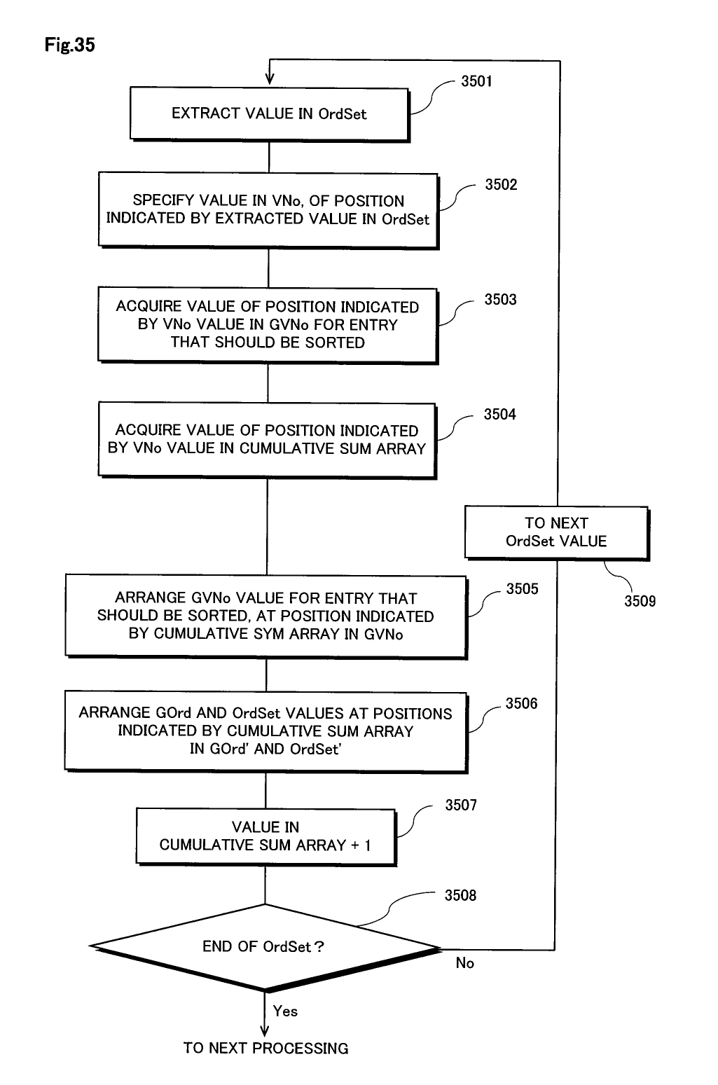

Next, local sorting processing is executed in each PMM. As shown in FIG. 35, each PMM extracts a value in the order set array OrdSet (step 3501) and then specifies a value (pointer value) of the position indicated by the value in the array OrdSet, in the pointer array VNo (step 3502). After that, each PMM acquires a value of the position indicated by the value in the pointer array VNo, in the global value number array GVNo for the entry that should be sorted (step 3503). This value is used for value storage processing, which will be described later. Meanwhile, in the cumulative sum array, too, a value of the position indicated by the pointer array VNo is acquired (step 3504). This value is used for designating the position in the array in value storage processing, which will be described later.

Next, value storage processing is executed. Each PMM arranges the value in GVNo for the entry that should be sorted, acquired at step 3502, at the position indicated by the value in the cumulative sum array acquired at step 3504 in the previously generated array GVNo (step 3505). Also, each PMM arranges the values in the global order set array GOrd and the order set array OrdSet at the position indicated by the value in the cumulative sum array acquired at step 3504 in the arrays GOrd′ and OrdSet′ (step 3506). Then, the value in the cumulative sum array used for the processing is incremented (step 3507).

The above-described processing of steps 3501 to 3507 is sequentially executed for all the values in the array OrdSet (see steps 3508 and 3509).

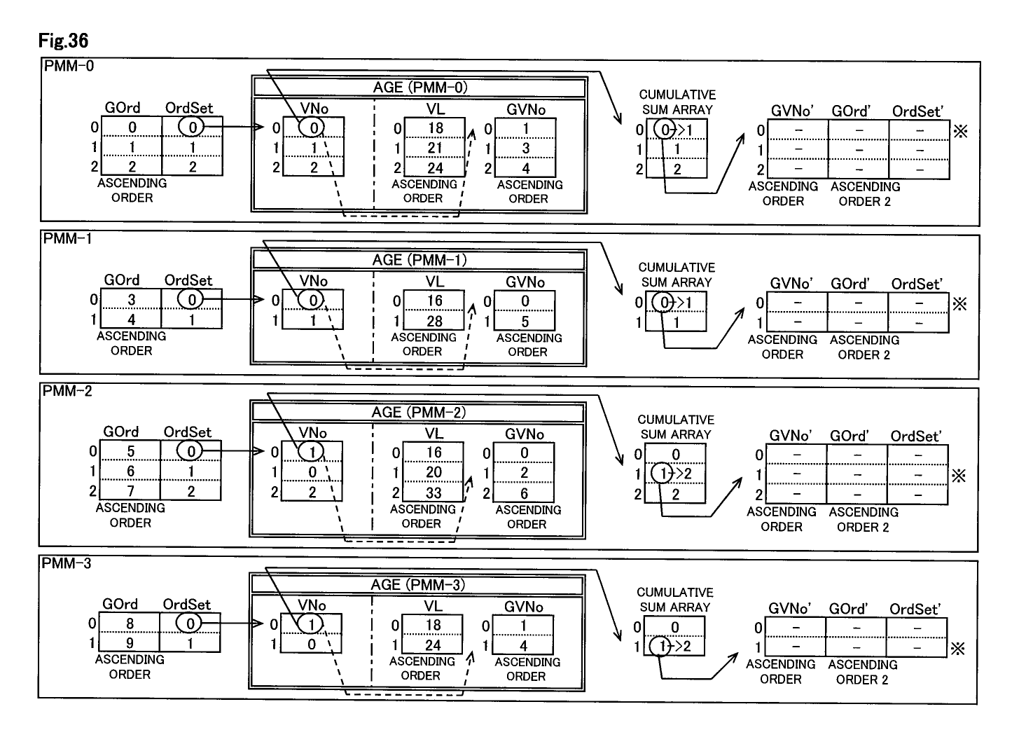

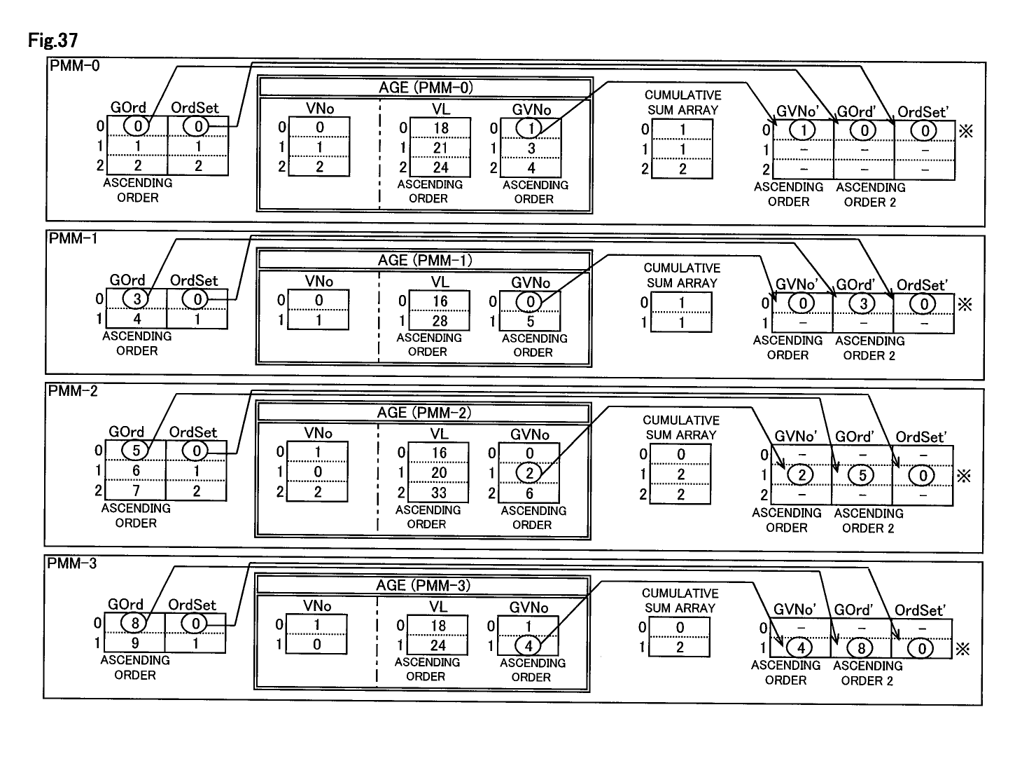

FIGS. 36 and 37 are views showing an example of state where local sorting processing is executed in each PMM. For example, for PMM-0, it can be understood that, in FIG. 36, extraction of a value “0” in the array OrdSet (see step 3501), specification of a value “0” in the array VNo, of the position indicated by the value “0” in OrdSet (see step 3502), acquisition of a value “1” in the array GVNo, of the position indicated by the value “0” in the array VNo (step 3503), and acquisition of a value “0” in a cumulative sum array, of the position indicated by the value “0” in the array VNo (step 3504) are executed. It can also be understood that the value in the cumulative sum array is changed from “0” to “1” after the acquisition of the cumulative sum array (see step 3507).

Moreover, for PMM-0, it can be understood that, in FIG. 37, a value “1” in the array GVNo, a value “0” in the array GOrd and a value “0” in the array OrdSet for the entry “age”are arranged in the arrays GVNo, GOrd′ and OrdSet′, at the positions indicated by the value in the cumulative sum array acquired at step 3503 (see steps 3505 and 3506). It can be understood that, in FIGS. 36 and 37, the processing shown in steps 3501 to 3505 is similarly executed in the other PMMs.

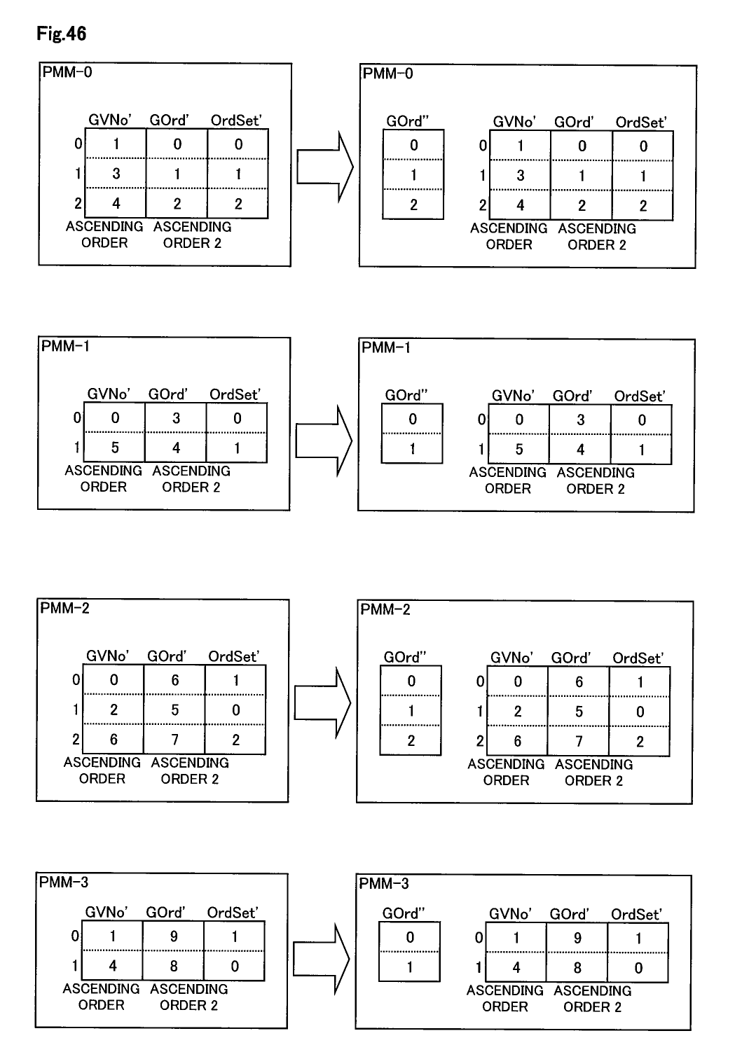

By the local sorting processing (that is, sorting processing in each PMM), an array as shown in FIG. 46 can be provided. After the local sorting processing, the processing shifts to processing for packet communication between PMMs. In this embodiment, it is assumed that buses of four channels (packet transmission lines) exist clockwise in FIG. 1 and that four buses (packet transmission lines) also exist counterclockwise. The clockwise buses are referred to as U-0 to U-3 and the counterclockwise buses are referred to as D-0 to D-3.

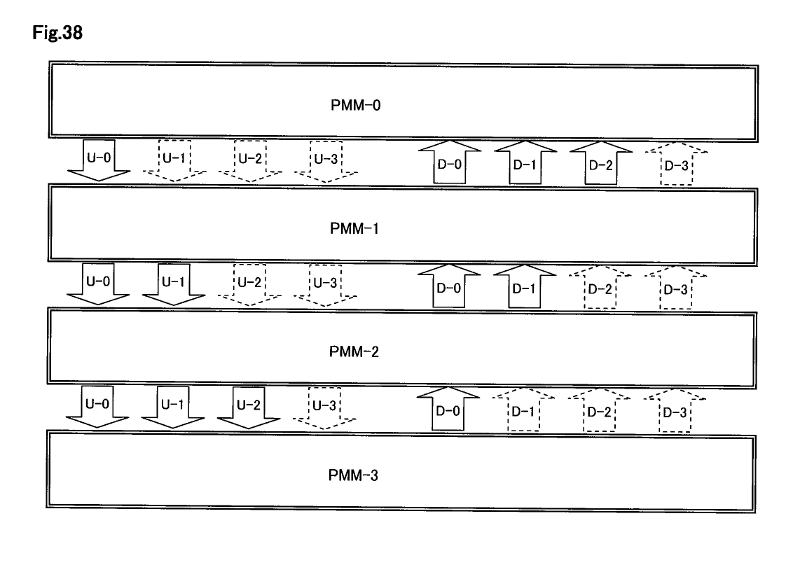

As shown in FIG. 38, the buses U-0, U-1 and U-2 transmit the global order set arrays GOrd′ and the global value number arrays GVNo′ of PMM-0, PMM-1 and PMM-2. The buses D-0, D-1 and D-2 transmit the global order set arrays GOrd′ and the global value number arrays GVNo′ of PMM-3, PMM-2 and PMM-1 in the direction opposite to the buses U-0 to U-2.

For example, PMM-0 uses U-0 to send a packet containing its own GOrd′ and GVNo′ and receives packets containing GOrd′ and GVNo′ of PMM-3 to PMM-0 from D-0 to D-2. PMM-1 uses U-1 and D-2 to send a packet containing its own GOrd′ and GVNo′ and receives packets containing GOrd′ and GVNo′ of PMM-0, PMM-3 and PMM-2 from U-0, D-0 and D-1.

PMM-2 uses U-2 and D-1 to send a packet containing its own GOrd′ and GVNo′ and receives packets containing GOrd′ and GVNo′ of PMM-0, PMM-1 and PMM-3 from U-0, U-1 and D-0. PMM-3 uses D-0 to send a packet containing its own GOrd′ and GVNo′ and receives packets containing GOrd′ and GVNo′ of PMM-0 to PMM-2 from U-0 to U-2.

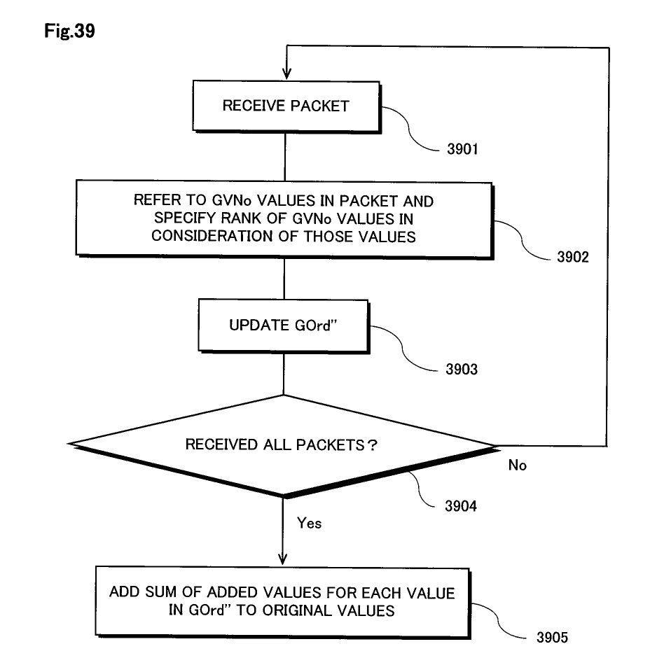

The processing in each PMM will be described hereinafter. As shown in FIG. 39, when a packet is received from one of the buses (step 3901), the PMM refers to the values in the value GVNo′ of the packet and specifies the rank of the values in its own GVNo′ in consideration of those values (step 3902). The values corresponding to the rank are housed in a new global order set array GOrd″ (step 3903). When the same values are in the array GVNo′, the values in GOrd′ corresponding to these values are referred to and the value corresponding to the smaller GOrd′ value is on the higher level.

The PMM executes similar processing with respect to all the received packets (see step 3904). Therefore, GOrd″ is generated by the number of received packets.

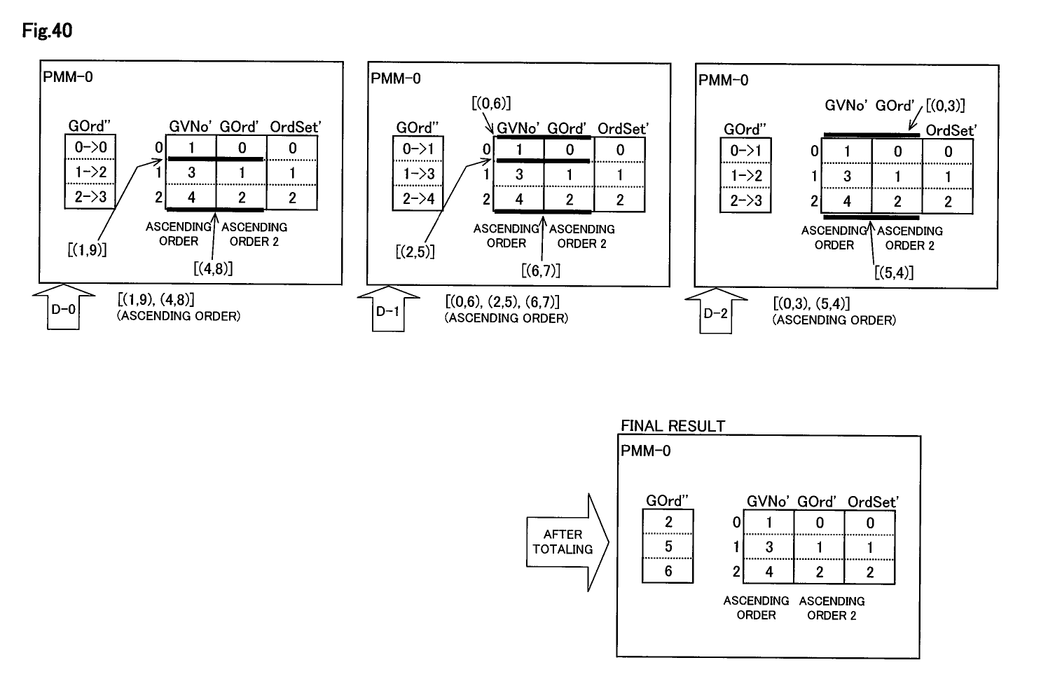

FIGS. 40 to 43 show examples in which values in a new global order set array GOrd″ are generated in PMM-0 to PMM-2. In each of these figures, the third block from left represents the newly generated Gord″.

If all the packets have been received, the PMM calculates the sum of added values to each value in each GOrd″ and adds the calculated sum to the original values in GOrd″ (step 3905). The array formed by the result of this addition is the global order set array that should be provided ultimately. The right end block in each of FIGS. 40 to 43 is equivalent to the global order set array in which GOrd″ has been found.

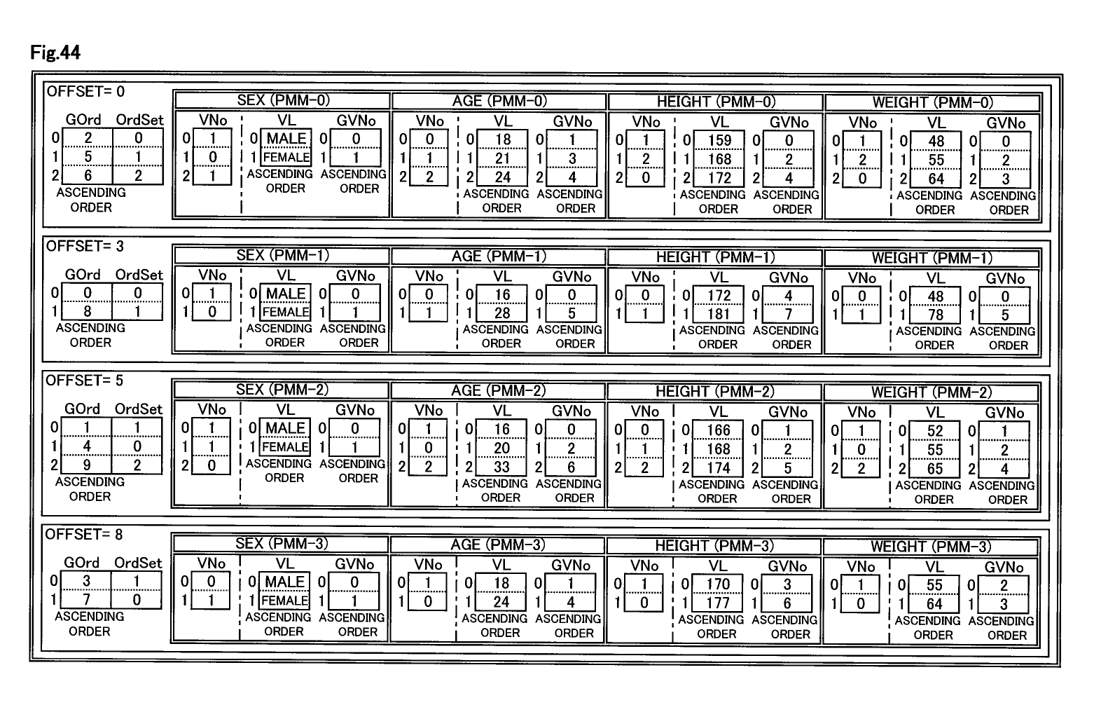

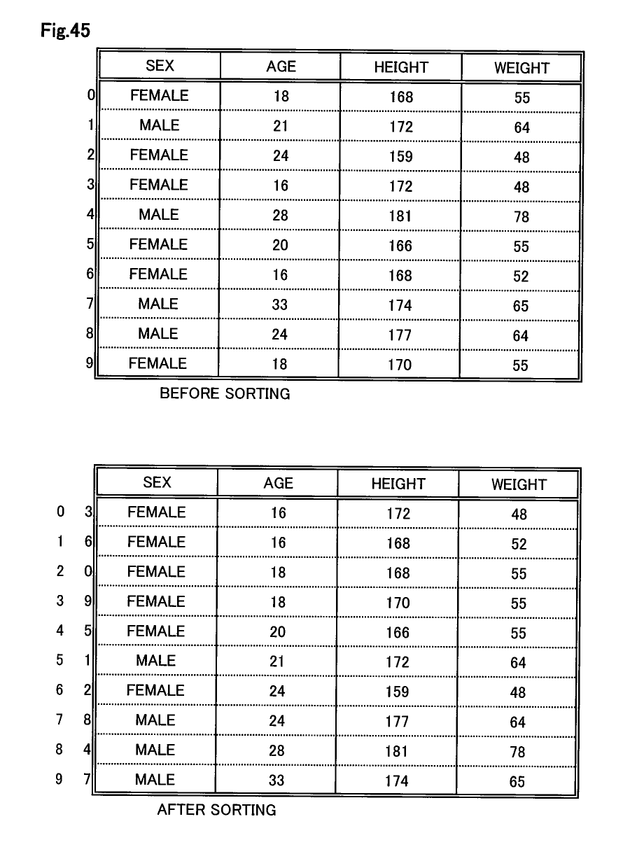

The value addition processing (step 3905) need not be carried out after the reception of all the packets. Every time a packet is received and a new global order set array GOrd″ is generated, the added values to GOrd″ may be added to the original values. In this manner, the global order set GOrd″ showing the sorting order is completed. As the processing ends, the generated GOrd″ can be substituted for GOrd, and OrdSet′ can be substituted for OrdSet. Thus, in each PMM, an array as shown in FIG. 44 can be provided. Here, by sequentially extracting the records in order of the array GOrd, sorted spreadsheet data can be provided (see FIG. 45).

As described above, as the generated GOrd″ is substituted for GOrd and OrdSet′ is substituted for OrdSet, for example, an array as shown in FIG. 44 is acquired in each PMM. Here by sequentially extracting the records in order of the array GOrd, sorted spreadsheet data can be provided (see FIG. 45).

### System Construction and Significance of This Invention

In the information processing system according to this invention, for example, as each PMM is connected to a terminal device that servers as a front end via a ring shape channel and receives a command from the terminal device, the above-described processing such as compile, search, cross-totaling and sorting can be executed in the PMM. Each PMM can send out a packet by using one of the buses and synchronization or the like between PMMs need not be controlled from outside.

The control device may include a general-purpose CPU in addition to an accelerator chip having a hardware construction for repetitive operations such as the above-described compile and search. The general-purpose CPU can interpret a command transmitted thereto from the terminal device via a channel and can provide an instruction necessary for the accelerator chip.

Moreover, it is desirable that a register group for housing various arrays necessary for works such as order set array and global order set array is provided in the control device, particularly in the accelerator chip therein. Thus, once the values necessary for processing are loaded onto the register from the memory, the control device can read out values from the register or write values into the register without accessing the memory during the above-described processing operation for compile, search, cross-totaling and sorting. This enables significant reduction in the number of times of memory access (loading before operation processing, and writing of processing results) and enables significant reduction in the processing time.

Next, the significance of the array GOrd and array GVNo introduced in this invention will be described. In this invention, the global order set array GOrd indicates the position (rank) of each record of spreadsheet data controlled by each PMM, in global spreadsheet data formed by aggregating local spreadsheet data controlled by each PMM. That is, in this invention, the position information of records is separated into global components and local components by the global order set array GOrd and the order set array OrdSet. This enables handling of the global spreadsheet data and also enables execution of processing by each single PMM.

In this embodiment, the PMM is constructed to hold an information block for each entry. However, even when the PMM holds spreadsheet data as it is, the above-described GOrd functions similarly in the following manner.

For example, if the entry value of each entry is extracted in order of the values in the global order set array GOrd in the state where compile processing has been finished (see, for example, FIG. 20) in this embodiment, a view of the entire spreadsheet data can be created. The same applies to the state where search has been finished (see, for example, FIG. 29) and the state where sorting has been finished (see, for example, FIG. 44).

More specifically, for example, in FIG. 20, as the control circuit 20 of PMM-2 receives a value “5” indicating a rank, a value “0” in the (local) order set array OrdSet associated with the value “5” in the global order set array GOrd is specified. Moreover, a value “1” in the pointer array PV is specified for the entry “age”, and then an entry value “20” in the value list VL can be specified. Of course, a value in the pointer array PV and an entry value in the value list VL specified by the value in the array PV are specified also for the other entries. This enables extraction of a record corresponding to the value indicating the rank.

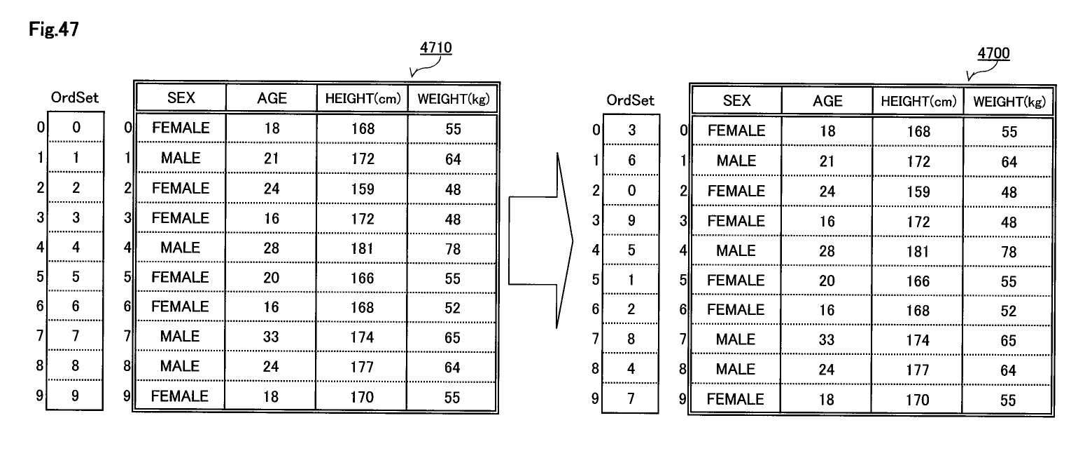

Also, even in a construction where no information block is held, the extraction of a corresponding record can be realized in response to the reception of the value indicating the rank as described above. This will be described later with reference to FIG. 47.

Next, the significance of the array GOrd will be described further with reference to a construction where no information block is held. For example, as shown by reference numeral 4710 in FIG. 47, it is assumed that spreadsheet data is realized by sorting the values in the order set array as address information for specifying entries instead of sorting values (entry values) themselves, and rearranging the values in the array. The order set array OrdSet as shown by reference numeral 4700 in FIG. 47 indicates the order of records after sorting.

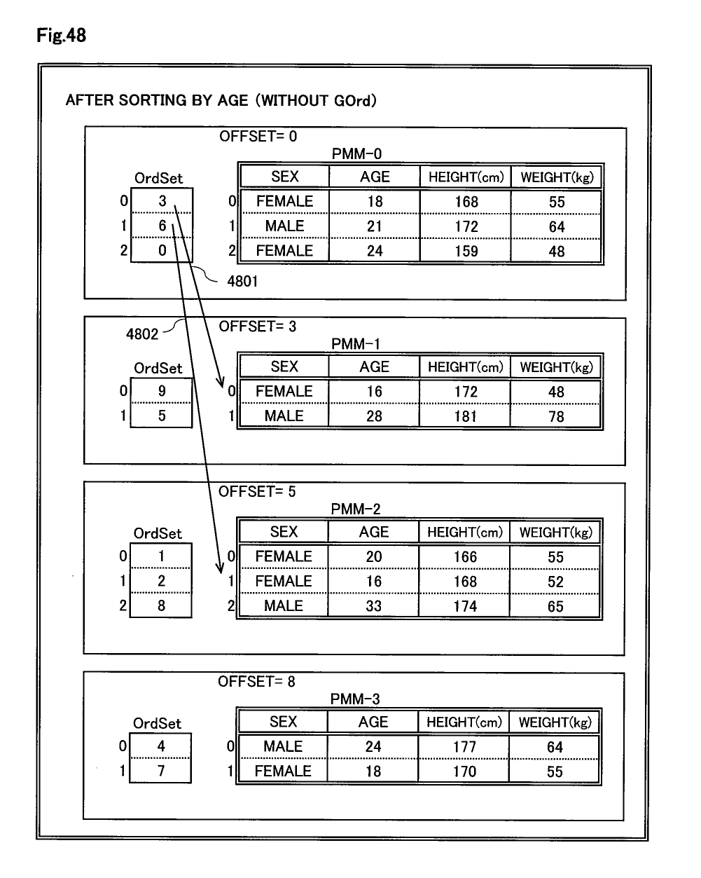

Next, distributive control and grasp of the order set array OrdSet and the main body of the spreadsheet data (see reference numera l4700 in FIG.47) in plural PMMs is considered. An example is shown in FIG. 48 where the order set array OrdSet is divided and also the spreadsheet data main body is divided so that sets of the divided array OrdSet and spreadsheet data main body are distributively controlled by the PMMs. In this case, a value in the array OrdSet of one PMM may indicate a record held by another PMM (see, for example, arrows 4801 and 4802). Therefore, there is practically no processing that can be executed singly by each PMM. Also, in the example of FIG. 48, in the case of further narrowing (searching) the entry “age” to “female”, a clear standard cannot be created with respect to how an array housing the values indicating the narrowed records should be distributively controlled. In short, search in the above-described state is practically impossible.

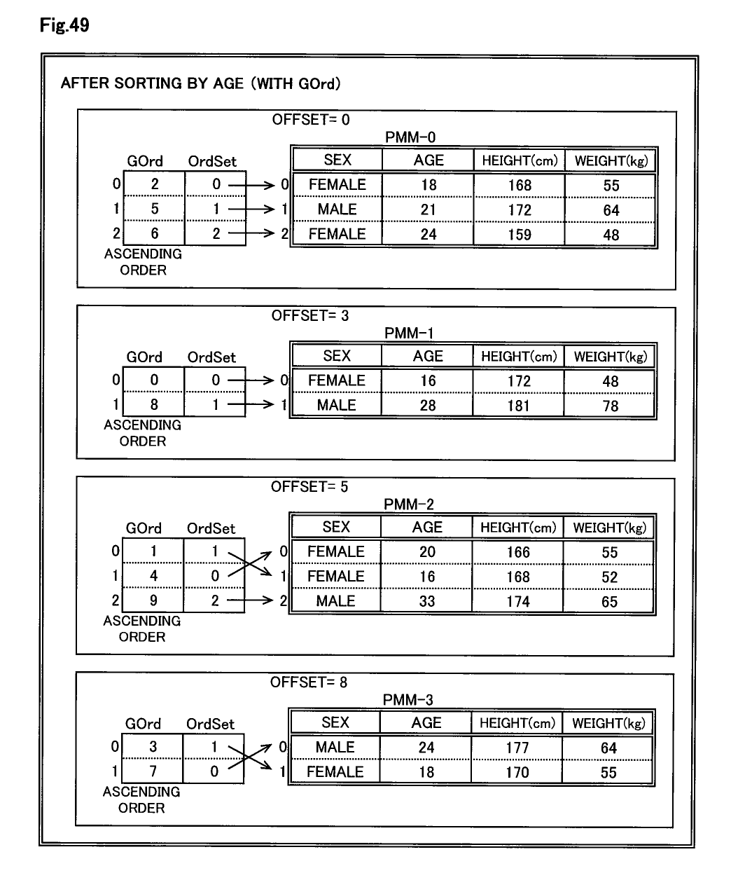

On the contrary, as show in FIG. 49, the ranks of locally sorted records in a subset of spreadsheet data grasped by each PMM are controlled by the order set array OrdSet, and the global order set array GOrd controls the rank in the entirety, of each of the sorted records. Since the (local) order set array OrdSet indicates the records in the subset of the spreadsheet data controlled by each PMM itself, processing by the PMM alone is possible.

Also, the extraction of a record in response to the reception of a value indicating a rank in the example shown in FIG. 49 will be described hereinafter. For example, as the control circuit of PMM-0 receives a value “5” indicating a rank, a value “1” in the (local) order set array OrdSet associated with the value “5” in the global order set array GOrd is specified. Thus, a record of “sex: male”, “age: 21”, “height: 172” and “weight: 64” in PMM-0 is extracted.

Moreover, what should be particularly noted here is that the values in the (local) order set array OrdSet reflect local sorting and therefore their ranks may be reversed, whereas the values in the global order set array GOrd are in ascending order. This enables high-speed processing between PMMs and processing within a PMM. Of course, the values in the global order set array GOrd are in ascending order even after search processing or cross-totaling processing.

The ascending order in the array GOrd as described above has the following advantages. For example, in the above-described search processing, since the array GOrd (what is used in the processing is the array GOrd′) is in ascending order, comparison of values can be realized at a high speed (see FIGS. 24 to 28). Similarly, in the above-described sorting processing, too, since the array GOrd (what is used in the processing is the array GOrd′) is in ascending order (and the array GVNo, which will be described later, is also in ascending order), value comparison processing can be realized at a high speed (see FIGS. 39 to 43).

Also, in the case of extracting a sorted record and creating a sorted view, since the global order set array GOrd is in ascending order, each PMM can output the data in order from the leading record. Therefore, the processing can be realized at a high speed.

Also, it is useful to specify and extract an entry value by utilizing the global value number array GVNo, that is, to receive, in the PMM, information indicating the rank of a value (entry value) in the global spreadsheet data and extract an entry value corresponding to the rank. For example, in FIG. 20, in order to find the leading entry value, that is, the 0^{th} entry value for the entry “age”, PMM-1, having received a command indicating a value rank “0”, can specify a value “16” in the value list VL associated with the value “0” in the global value number array GVNo. Of course, PMM-2, having received a command, may operate similarly. Moreover, also the global value number array GVNo is in ascending order. This is because the order of entry values in the (local) value list controlled in each PMM is maintained if the entry values are in ascending order. Therefore, in the above-described sorting processing, value comparison processing can be realized at a high speed (see FIGS. 39 to 43).

This invention is not limited to the above-described embodiment and various changes can be made within the scope of the invention described in the claims. It is a matter of course that these changes are included within the scope of this invention.

In the above-described embodiment, PMMs are connected in a ring shape by the first buses (first transmission lines) that transmit packets clockwise and the second buses (second transmission lines) that transmit packets counterclockwise. Such a construction is advantageous because the delay in packet transmission can be made even. However, the form of transmission lines is not limited to this and other forms of transmission lines such as bus type may be employed.

Also, in this embodiment, PMMs, each having a memory, an interface and a control circuit, are used. However, not limited to this, personal computers, servers or the like may be employed instead of PMMS, as information processing units that distributively control local spreadsheet data. Alternatively, a construction may be employed in which a single personal computer or server holds plural information processing units. Also in these cases, the information processing units receive values indicating the ranks of records and can specify the records with reference to the global order set array GOrd. It is also possible to specify an entry value by referring to the global value number array.

Moreover, while PMMs send packetized data to transmission lines in the above-described embodiment, it is a matter of course that the transmission is not limited to this and that data can be transmitted in other forms than packets. Also, for the transmission lines between information processing units, a so-called network type or bus type may be employed.

As a construction in which plural information processing units are provided in a single personal computer is employed, this invention can be utilized in the following manner. For example, three spreadsheet data for Sapporo branch office, Tokyo branch office and Fukuoka branch office are prepared, and usually, search, totaling, sorting and the like are executed at each branch office. Then, in consideration of global spreadsheet data integrating the three branch offices, the spreadsheet data of each branch office is regarded as a partial table of the entire table, and search, sorting and totaling with respect to the global spreadsheet data can be realized.

Of course, also in the case of connecting plural personal computers via a network, processing with respect to local spreadsheet data that are distributively controlled by the personal computers and processing with respect to global spreadsheet data can be similarly realized.

In the above-described embodiment, the erasure of the same value is realized by erasing the same value as each PMM's own value with reference to values in a packet received via a packet transmission line from a channel allocated to each PMM, for example, as shown at the second to fourth timing (FIGS. 11 to 13) in the compile processing. However, the erasure is not limited to this. By carrying out the erasure of the same value in the following manner, the erasure of the same value and the decision of the rank in each PMM's own list (or array) can be separated in the compile processing.

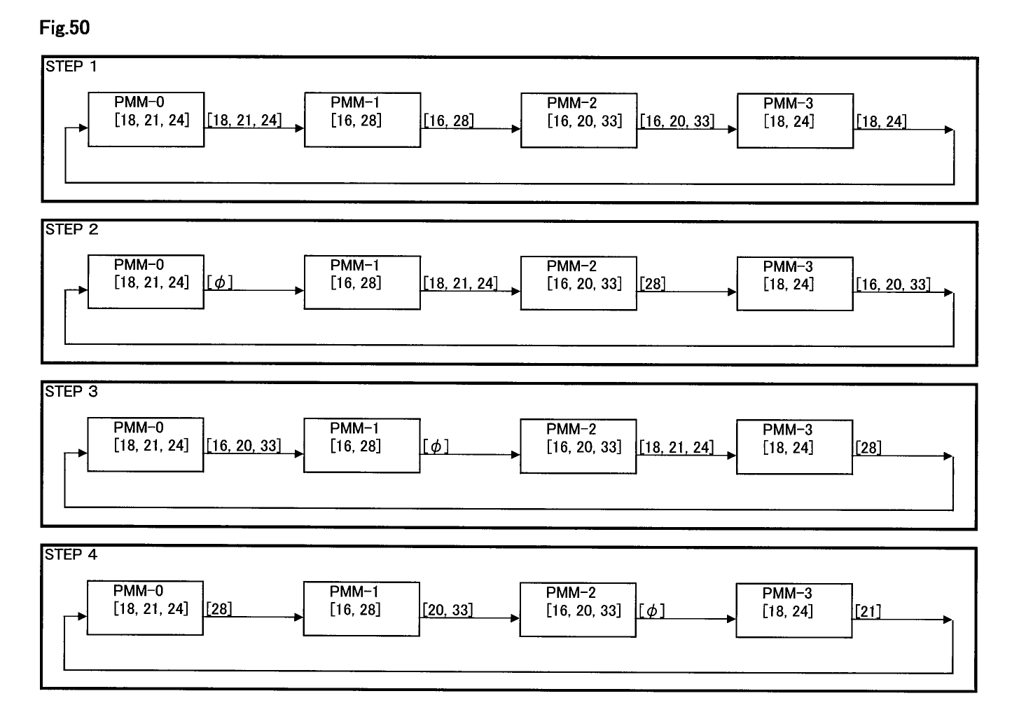

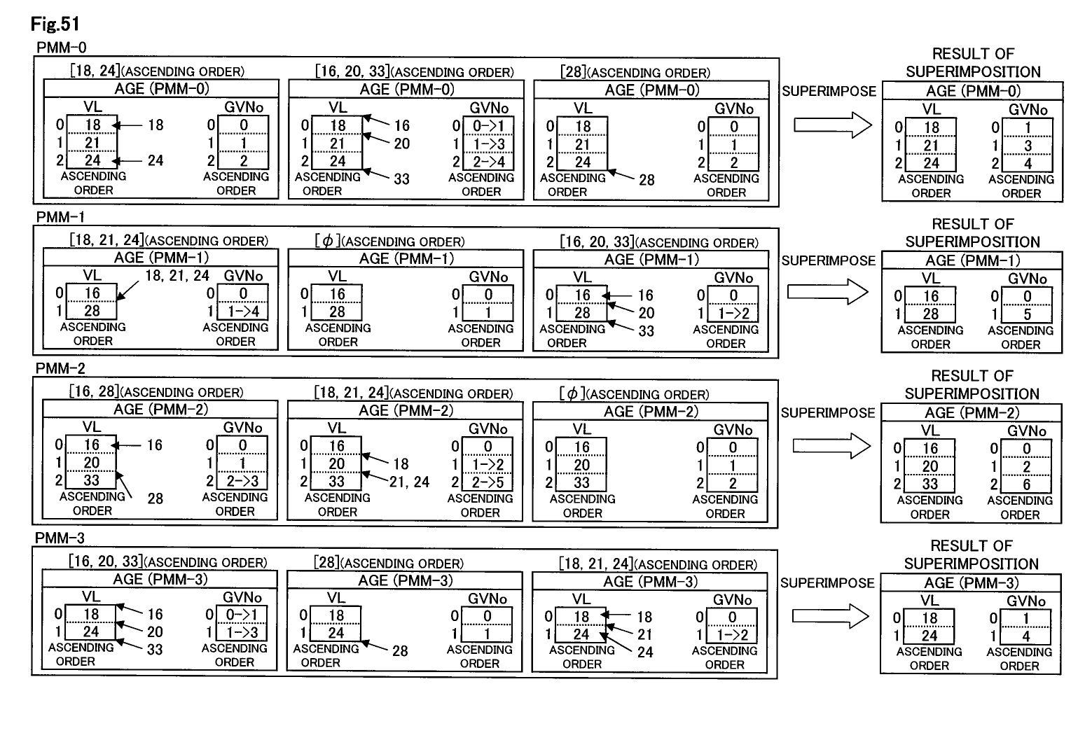

If each PMM sends the values in its own VL in a single direction to the ring shape packet transmission lines and the same value as the value in each PMM's own VL is found in a received packet, the packet may be sent to another PMM neighboring in the single direction after the same value is erased, as shown in FIG. 50. As shown at the top of FIG. 50, for example, PMM-0 sends values [18, 21, 24] in its own VL. On the other hand, PMM-0 receives values [18, 24] in PMM-3's VL from PMM-3. Here, as PMM-0 compares the values in its own VL with the values in PMM-3's VL and erases the duplex values in PMM-3's VL, a packet having [φ], that is, having no value, is sent from PMM-0 to PMM-1, as shown in the second stage of FIG. 50. If, at each PMM, erasing values in each PMM's own VL from values of in received VL and sending a packet containing values after the erasure into the single direction are repeated by the number of PMMs (in the example of FIG. 50, four times), a state where the same value is erased can be created. Moreover, as shown in FIG. 51, before the erasure of duplex values, every time a packet is received at each PMM, the values in VL of the received packet may be compared and the ranks in its own VL may be decided. After a packet is transmitted by the number of PMMs (in the above-described example, four times), the sum of added values of the values of the respective elements of GVNo can be calculated for each reception of a packet, thus acquiring the values in GVNo.

The decision of the rank and the erasure of the same value by packet transmission in the single direction shown in FIGS. 50 and 51 can be applied to sorting processing.

### INDUSTRIAL APPLICABILITY

This invention can be applied particularly to a system that manages a large volume of data, for example, database and data warehouse. More specifically, the invention can be utilized for large-scale scientific and technological calculations, key business management and office management including management of placed/received orders and stock exchange.

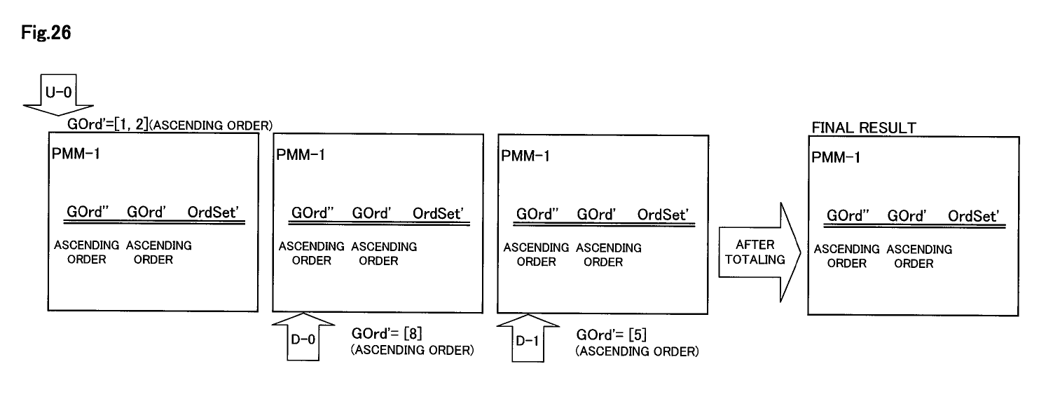

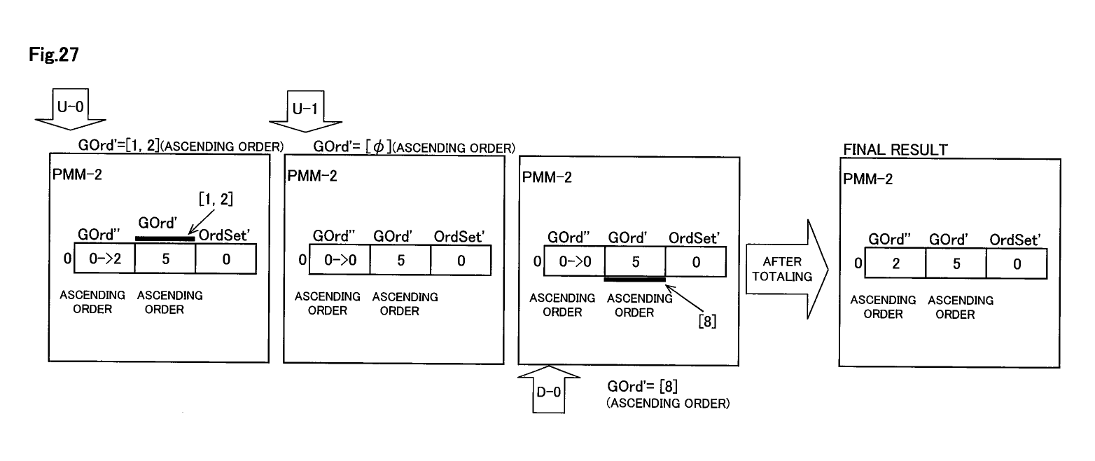

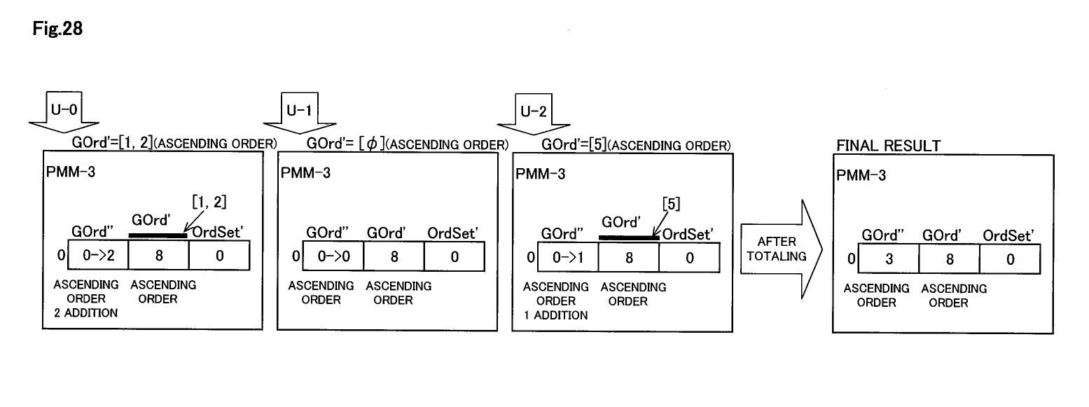

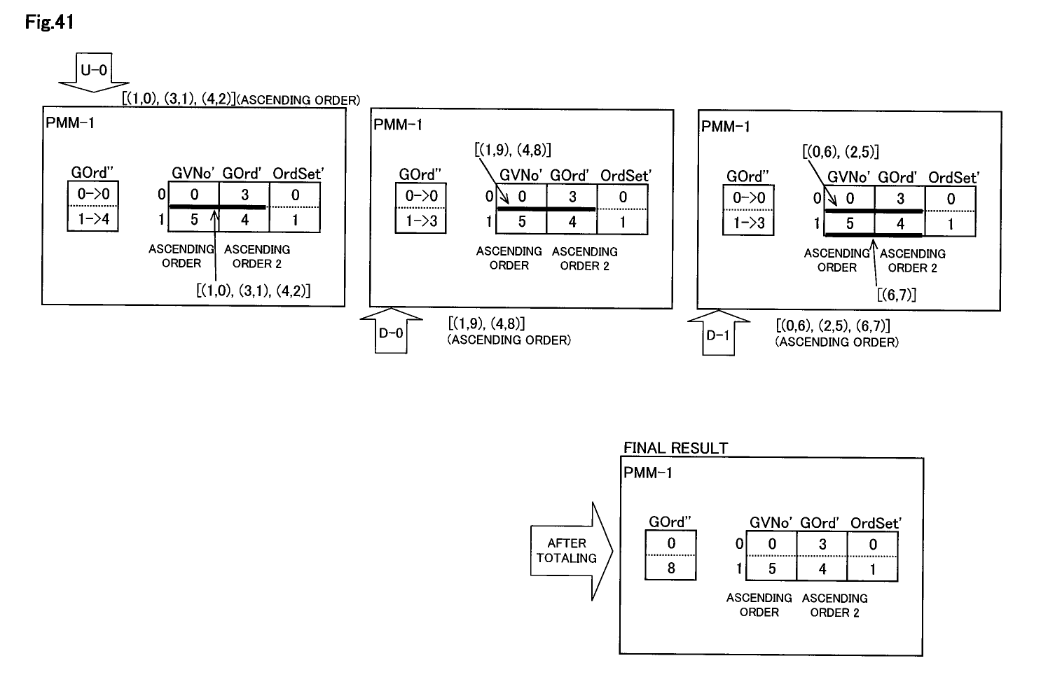

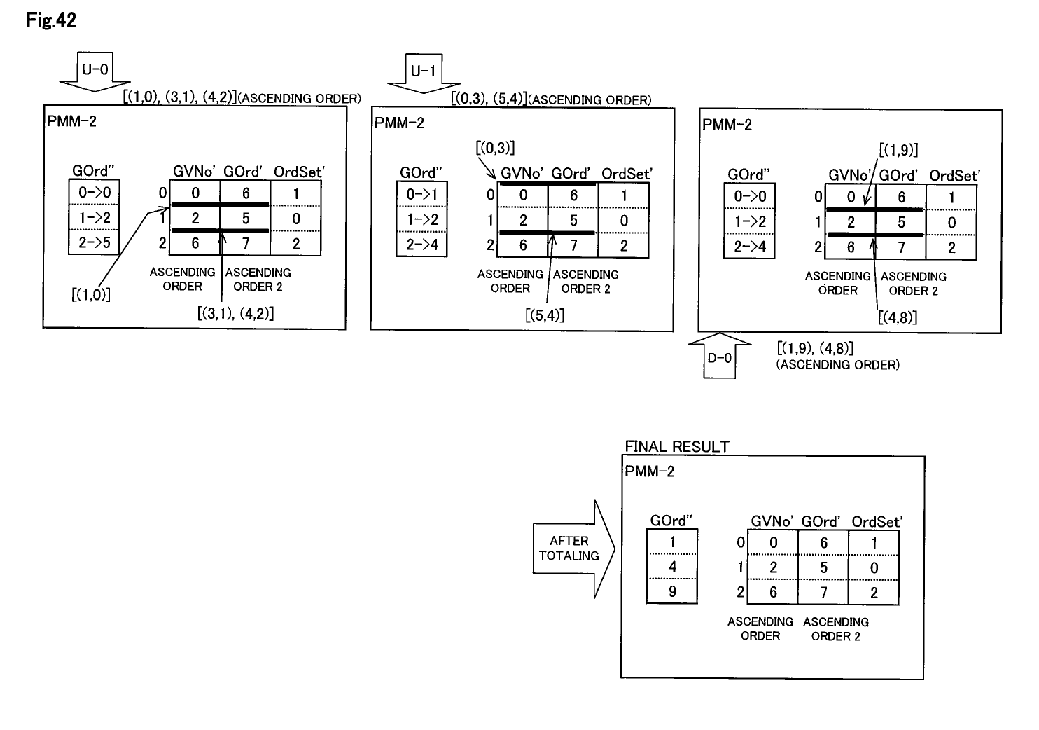

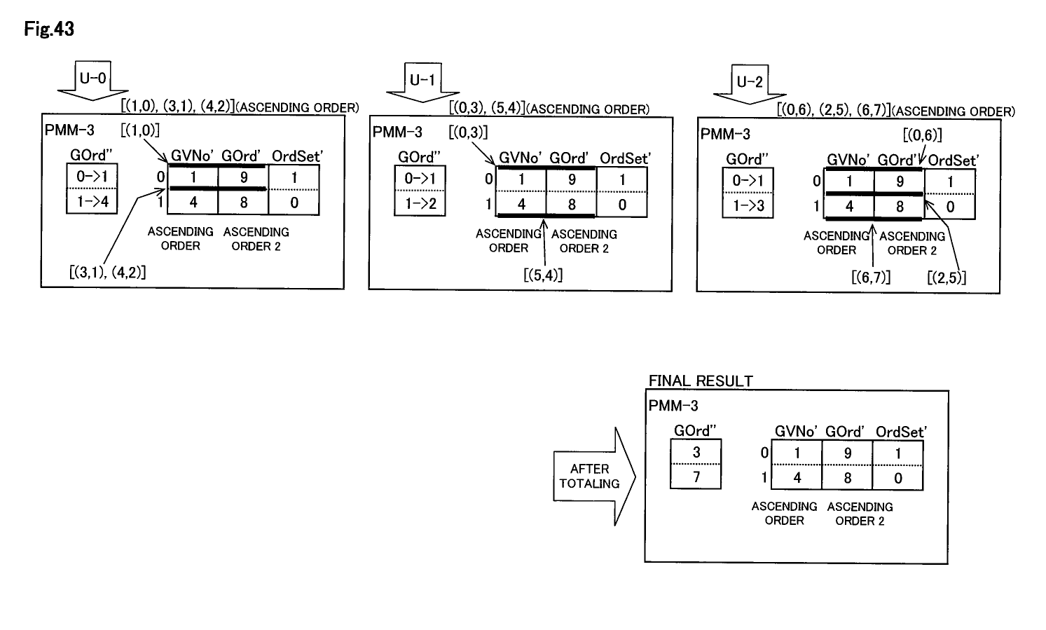

### BRIEF DESCRIPTION OF THE DRAWINGS

[FIG. 1] FIG. 1 is a block diagram schematically showing an information processing system according to an embodiment of this invention.

[FIG. 2] FIG. 2 is a view showing an exemplary structure of PMM according to an embodiment of this invention.

[FIG. 3] FIG. 3 is a view showing an example of spreadsheet data.

[FIG. 4] FIG. 4 is a view for explaining the principle of a structure for holding spreadsheet data in this embodiment.

[FIG. 5] FIG. 5 is a view for explaining an array distributively controlled and grasped by each PMM and its values in this embodiment.

[FIG. 6] FIG. 6 is a view showing an example of spreadsheet data initially controlled distributively in each of PMM-0 to PMM-4.

[FIG. 7] FIG. 7 is a view showing an example of spreadsheet data initially controlled distributively in each of PMM-0 to PMM-4.

[FIG. 8] FIG. 8 is a flowchart schematically showing compile processing according to this embodiment.

[FIG. 9] FIG. 9 is a view showing an arrangement of values into a global order set array GOrd in the example shown in FIGS. 6 and 7.

[FIG. 10] FIG. 10 is a view showing an example of packet transmission in compile processing according to this embodiment.

[FIG. 11] FIG. 11 is a view showing an example of packet transmission in compile processing according to this embodiment.

[FIG. 12] FIG. 12 is a view showing an example of packet transmission in compile processing according to this embodiment.

[FIG. 13] FIG. 13 is a view showing an example of packet transmission in compile processing according to this embodiment.

[FIG. 14] FIGS. 14A and 14B are flowcharts showing processing executed by a PMM in sending and receiving a packet, in compile processing according to this embodiment.

[FIG. 15] FIG. 15 is a view for explaining processing executed by a PMM when receiving a packet, in compile processing according to this embodiment.

[FIG. 16] FIG. 16 is a view for explaining processing executed by a PMM when receiving a packet, in compile processing according to this embodiment.

[FIG. 17] FIG. 17 is a view for explaining processing executed by a PMM when receiving a packet, in compile processing according to this embodiment.

[FIG. 18] FIG. 18 is a view for explaining processing executed by a PMM when receiving a packet, in compile processing according to this embodiment.

[FIG. 19] FIG. 19 is a flowchart showing a part of search processing according to this embodiment.

[FIG. 20] FIG. 20 is a flowchart showing processing executed before packet transmission, in search processing according to this embodiment.

[FIG. 21] FIG. 21 is a view showing an example of state where, in each PMM, the processing of FIG. 19 is executed and values are arranged in new global order set array GOrd′ and order set array OrdSet′ locally and in parallel.

[FIG. 22] FIG. 22 shows a state where an unnecessary area is deleted from an array (see reference numerals 2201 to 2204).

[FIG. 23] FIG. 23 is a view showing an example of packet transmission in search processing according to this embodiment.

[FIG. 24] FIG. 24 is a flowchart showing processing executed in a PMM when receiving a packet, in search processing according to this embodiment.

[FIG. 25] FIG. 25 is a view showing an example where values in a new global order set array GOrd″ are generated in PMM-0 according to this embodiment.

[FIG. 26] FIG. 26 is a view showing an example where values in a new global order set array GOrd″ are generated in PMM-1 according to this embodiment.

[FIG. 27] FIG. 27 is a view showing an example where values in a new global order set array GOrd″ are generated in PMM-2 according to this embodiment.

[FIG. 28] FIG. 28 is a view showing an example where values in a new global order set array GOrd″ are generated in PMM-3 according to this embodiment.

[FIG. 29] FIG. 29 is a view showing a new array acquired by search processing in this embodiment.

[FIG. 30] FIG. 30 is a flowchart showing a part of sorting processing according to this embodiment.

[FIG. 31] FIG. 31 is a view showing a state where, for an entry of “age”, an area having the same size as a value list VL is created in each PMM and an initial value “0” is given to each.

[FIG. 32] FIG. 32 is a view showing an example of count-up processing in each PMM.

[FIG. 33] FIG. 33 is a flowchart schematically showing a part of sorting processing (generation of a cumulative sum array) according to this embodiment.

[FIG. 34] FIG. 34 is a view showing an exemplary cumulative sum array according to this embodiment.

[FIG. 35] FIG. 35 is a flowchart showing local sorting processing executed in each PMM according to this embodiment.

[FIG. 36] FIG. 36 is a view showing an example of state where local sorting processing is executed in each PMM.

[FIG. 37] FIG. 37 is a view showing an example of state where local sorting processing is executed in each PMM.

[FIG. 38] FIG. 38 is a view showing an example of packet transmission in sorting processing according to this embodiment.

[FIG. 39] FIG. 39 is a flowchart showing processing executed by a PMM when receiving a packet, in sorting processing according to this embodiment.

[FIG. 40] FIG. 40 is a view showing an example where values in a new global order set array GOrd″ are generated in PMM-0 by sorting processing according to this embodiment.

[FIG. 41] FIG. 41 is a view showing an example where values in a new global order set array GOrd″ are generated in PMM-1 by sorting processing according to this embodiment.

[FIG. 42] FIG.42 is a view showing an example where values in a new global order set array GOrd″ are generated in PMM-2 by sorting processing according to this embodiment.

[FIG. 43] FIG. 43 is a view showing an example where values in a new global order set array GOrd″ are generated in PMM-3 by sorting processing according to this embodiment.

[FIG. 44] FIG. 44 is a view showing sorting results by sorting processing according to this embodiment.

[FIG. 45] FIG. 45 is a view showing an example of spreadsheet data sorted by an entry “age”, acquired by sorting processing according to this embodiment.

[FIG. 46] FIG. 46 is a view showing an array acquired by local sorting processing in this embodiment.

[FIG. 47] FIG. 47 is a view showing an example where sorting of spreadsheet data is realized by rearrangement of address information.

[FIG. 48] FIG. 48 is a view showing an example where the spreadsheet data shown in FIG. 47 is distributively controlled and grasped by each PMM without using a global order set array.

[FIG. 49] FIG. 49 is a view showing an example where the spreadsheet data shown in FIG. 47 is distributively controlled and grasped by each PMM, using a global order set array.

[FIG. 50] FIG. 50 is a view showing another exemplary technique for erasing the same value according to this invention.

[FIG. 51] FIG. 51 is a view showing decision of the ranks in each PMM in the case where the technique of FIG. 50 is used.

### DESCRIPTION OF REFERENCE NUMERALS AND SIGNS

12 PMM

14 first bus

16 second bus

20 control circuit

22 bus I/F

24 memory

26 bank

1. An information processing system comprising
a plurality of memory modules, each comprising a memory and a control device, and
a data transmission line that connects the memory modules and transmits a value of one memory module to another memory module, wherein
the memory of each memory module is arranged to hold a value list having values ordered in ascending order or descending order without duplication, and
the control device of each of the memory modules comprises:
data transmitting means that transmits a value contained in the value list to the other memory modules;
data receiving means that receives a value contained in the value list from the other memory modules; and
rank judging means that decides a global value rank in consideration of the values contained in the value lists of all the other memory modules, with reference to the value lists of the other memory modules received by the data receiving means, and stores the decided rank, at a position corresponding to the value in the present memory module, in a global rank storage array for storing the global value rank.

2. The information processing system as claimed in claim 1, characterized in that the rank judging means generates an auxiliary rank storage array in consideration of the value list of each of the other memory modules, combines values in the auxiliary rank storage array, and decides the value in the rank storage array.

3. The information processing system as claimed in claim 2, characterized in that the rank judging means generates the auxiliary rank storage arrays in parallel.

4. The information processing system as claimed in claim 1, characterized in that the modules are disposed adjacent to one another and the data transmission line connects adjacent modules and forms a ring-shaped data transmission line.

5. The information processing system as claimed in claim 4, characterized in that the data transmission line comprises a first data transmission line having one or more channels that transmit data from one memory module to an other memory module, and a second data transmission line having one or more channels that transmit data from the other memory module to the one memory module, wherein
the data transmitting means is arranged to transmit the value list of the present memory module between the adjacent memory modules by using either the one or the other data transmission line defined as a channel for each memory module, and
the data receiving means is arranged to receive the value list of the other memory module from a defined channel by utilizing the one and the other transmission lines, in parallel with the data transmission by the data transmitting means.

6. The information processing system as claimed in claim 1, characterized in that
to realize spreadsheet data expressed as an array of records each containing an entry and entry values belonging to the entry, the memory of each of the memory modules holds an information block including a value list in which the entry values are stored in order of entry value numbers corresponding to entry values belonging to a specific entry, and a pointer array in which pointer values for designating the entry value numbers are stored in order of a unique order set array, wherein a group of the information blocks held by the respective memories forms a global information block,
the control device of each memory module comprises offset value storage means that holds an offset value indicating which position of the pointer array is occupied by the information block controlled by the present memory module, as a subset of the global information block, and
global order set array generating means that generates a global order set array in the global information block on the basis of the offset value, and
the rank judging means decides the global value rank in the value list, as the value list, and stores the decided rank in a global value number array equivalent to the global rank storage array.

7. The information processing system as claimed in claim 6, characterized in that the rank judging means is arranged to generate an auxiliary value number array that stores a relative value rank in consideration of the value list of each of the other memory modules, and add the sum of the difference between the relative rank and the original rank judged for each of the other memory modules, to the original rank, thereby calculating the global value rank.

8. The information processing system as claimed in claim 6, further comprising same value erasing means disposed to erase a same value if the same value as the entry value in the value list of the present memory module exists among the entry values in the value list received by the data receiving means.

9. The information processing system as claimed in claim 6, characterized in that the control device of each memory module comprises:
flag array setup means that generates, with respect to an entry to be searched for, a flag array of the same size as the value list of the entry, and provides a specific value in a flag array corresponding to an entry value that meets a search condition;
search condition judging means that specifies a value in the pointer array corresponding to the position indicated by the order set array, with respect to the entry to be searched for, and after that, specifies a value in the flag array corresponding to the position indicated by the value in the pointer array, thereby judging whether a record corresponding to the value in the order set array meets the search condition or not; and
local search means that stores a value in the order set meeting the search condition and a value in the corresponding global order set into a second order set array and a second global order set array, respectively, and
the data transmitting means that transmits the second global order set array as the value list to the other modules, and the data receiving means receives the second global order set array as the value list from the other memory modules, and
wherein the system further comprises second rank judging means that judges a relative rank of the present memory module's value in the global order set array with respect to the other memory modules with reference to each of the received second global order set arrays, decides a rank in the global information block on the basis of the relative rank, and stores the rank in the global information block into a third global order set array equivalent to the global rank storage array, wherein the rank of a record that meets the search condition is indicated by the value in the third global order set array.

10. The information processing system as claimed in claim 9, characterized in that the second rank judging means is arranged to generate an auxiliary order set array that stores relative value ranks in consideration of the second global order set array of each of the other memory modules, and add the sum of the difference between the relative rank and the original rank judged for each of the other memory modules, to the original rank, thereby calculating the rank of the value in the global information block.

11. The information processing system as claimed in claim 6, characterized in that the control device of each memory module further comprises third rank judging means that decides the rank of the value in the global order set array in accordance with a value corresponding to the global order set array, of a global value number array related to a predetermined entry, and stores the value in the global order set array at a position corresponding to the decided rank, in a fourth global order number array, and the fourth global order set array is formed by rearranging the global order set in accordance with the value in the global value number array.

12. The information processing system as claimed in claim 6, characterized in that the control device of each memory module further comprises:
number-of-existence array generating means that generates, with respect to an entry to be sorted, a number-of-existence array of the same size as the value list of the entry, and arranges the number of values in the order set array that designate each of the entry values in the value list;
cumulative sum array generating means that accumulates the values in the number-of-existence array, calculates the cumulative sum indicating the leading position of a record having the corresponding entry value when sorted within the memory module, and arranges the cumulative sum in a cumulative sum array; and
local sorting means that generates a second global value number array, the fourth global order set array and a third order set array, and arranges, on the basis of the cumulative sum in the cumulative sum array corresponding to the entry value indicated by the value in the order set array, a global value number corresponding to entry value at a position indicated by the cumulative sum in the second global value number array, and arranges the value in the order set array and the value in the corresponding global order set array at positions indicated by the cumulative sum in the third order set array and the fourth global order set array, respectively, and
wherein the data transmitting means transmits at least a second global value number array as the value list, and the data receiving means receives second global value number arrays of the other memory modules as the value list, and
the system further comprises fourth rank judging means that judges a relative rank of the present memory module's value in the second global value number array with respect to the other memory modules with reference to each of the received second global value number arrays, and stores the rank in the global information block into a fifth global order set array equivalent to the global order storage array, and the rank of the sorted record is indicated by the value in the fifth global order set array.

13. The information processing system as claimed in claim 12, characterized in that the fourth rank judging means is arranged to generate an auxiliary order set array that stores relative value ranks in consideration of the second global value number array of each of the other memory modules, and add the sum of the difference between the relative rank and the original rank judged for each of the other memory modules, to the original rank, thereby calculating the rank in the global information block.

14. The information processing system as claimed in claim 1, characterized in that the control device of the memory module has a register group to be used as the array, and calculation using the array is executed without accessing the memory.

15. An information processing method in an information processing system comprising the steps of:
(a) providing a plurality of memory modules, each having a memory and a control device, and
a data transmission line that connects the memory modules and transmits a value of one memory module to another memory module,
wherein the memory of each memory module is arranged to hold a value list having values ordered in ascending order or descending order without duplication;
(b) transmitting a value contained in the value list to the other memory modules;
(c) receiving a value contained in the value list from the other memory modules; and
(d) deciding a global value rank in consideration of the values contained in the value lists of all the other memory modules, with reference to the value lists of the other memory modules received at the receiving step, and storing the decided rank at a position corresponding to the value in the present memory module, in a global rank storage array for storing the global value rank.

16. The information processing method as claimed in claim 15, characterized in that the deciding step further comprises generating an auxiliary rank storage array in consideration of the value list of each of the other memory modules, synthesizing a value in the auxiliary rank storage array, and deciding the value in the rank storage array.

17. The information processing method as claimed in claim 16, wherein said auxiliary rank storage arrays are generated in parallel.

18. The information processing method as claimed in claim 15, characterized in that the modules are disposed adjacent to one another and the data transmission line connects adjacent modules and forms a ring-shaped data transmission line.

19. The information processing method as claimed in claim 18, characterized in that the data transmission line comprises a first data transmission line having one or more channels that transmit data from one memory module to an other memory module, and a second data transmission line having one or more channels that transmit data from the other memory module to the one memory module,
wherein the transmitting step further comprises transmitting the value list of the present memory module between the adjacent memory modules by using either the one of the other data transmission line defined as a channel for each memory module, and
the receiving step further comprises receiving the value list of the other memory module from a defined channel by utilizing the one and the other transmission lines, in parallel with the data transmission by the transmitting step.

20. The information processing method as claimed in claim 15, characterized in that
to realize spreadsheet data expressed as an array of records each containing an entry and entry values belonging to the entry, the memory of each of the memory modules holds an information block including a value list in which the entry values are stored in order of entry value numbers corresponding to entry values belonging to a specific entry, and a pointer array in which pointer values for designating the entry value numbers are stored in order of a unique order set array, wherein a group of the information blocks held by the respective memories forms a global information block,
in each memory module, the method comprises an offset value storage step of holding an offset value indicating which position of the pointer array is occupied by the information block controlled by the present memory module, as a subset of the global information block, and
a global order set array generating step of generating a global order set array in the global information block on the basis of the offset value, and
the deciding step further comprises deciding the global value rank in the value list, as the value list, and storing the decided rank in a global value number array equivalent to the global rank storage array.

21. The information processing method as claimed in claim 20, characterized in that the deciding step further comprises generating an auxiliary value number array that stores a relative value rank in consideration of the value list of each of the other memory modules, and adding the sum of the difference between the relative rank and the original rank judged for each of the other memory modules, to the original rank, thereby calculating the global value rank.

22. The information processing method as claimed in claim 20, further comprising a same value erasing step of erasing a same value from the value list received at the data receiving step if the same value as the entry value in the value list of the present memory module exists among the entry values in the value list received.

23. The information processing method as claimed in claim 20, characterized in that, in each memory module, the method further comprises:
a flag array setup step of generating, with respect to an entry to be searched for, a flag array of the same size as the value list of the entry, and providing a specific value in a flag array corresponding to an entry value that meets a search condition;
a search condition judging step of specifying a value in the pointer array corresponding to the position indicated by the order set array, with respect to the entry to be searched for, and after that, specifying a value in the flag array corresponding to the position indicated by the value in the pointer array, thereby judging whether a record corresponding to the value in the order set array meets the search condition or not; and
a local search step of storing a value in the order set meeting the search condition and a value in the corresponding global order set into a second order set array and a second global order set array, respectively, and that
at the data transmitting step, the second global order set array is transmitted as the value list to the other modules, and at the data receiving step, the second global order set array is received as the value list from the other memory modules, and
a second deciding step of judging a relative rank of the present memory module's value in the global order set array with respect to the other memory modules with reference to each of the received second global order set arrays, deciding a rank in the global information block on the basis of the relative rank, and storing the rank in the global information block into a third global order set array equivalent to the global rank storage array, wherein the rank of a record that meets the search condition is indicated by the value in the third global order set array.

24. The information processing method as claimed in claim 23, characterized in that the second deciding step further comprises generating an auxiliary order set array that stores relative value ranks in consideration of the second global order set array of each of the other memory modules, and adding the sum of the difference between the relative rank and the original rank judged for each of the other memory modules, to the original rank, thereby calculating the rank of the value in the global information block.

25. The information processing method as claimed in claim 24, characterized in that, in each memory module, the method further comprises a third deciding step of deciding the rank of the value in the global order set array in accordance with a value corresponding to the global order set array, of a global value number array related to a predetermined entry, and storing the value in the global order set array at a position corresponding to the decided rank, in a fourth global order number array, and the fourth global order set array is formed by rearranging the global order set in accordance with the value in the global value number array.

26. The information processing method as claimed in claim 20, characterized in that, in each memory module, the method further comprises:
a number-of-existence array generating step of generating, with respect to an entry to be sorted, a number-of-existence array of the same size as the value list of the entry, and arranging the number of values in the order set array that designate each of the entry values in the value list;
a cumulative sum array generating step of accumulating the values in the number-of-existence array, calculating the cumulative sum indicating the leading position of a record having the corresponding entry value when sorted within the memory module, and arranging the cumulative sum in a cumulative sum array; and
a local sorting step of generating a second global value number array, the fourth global order set array and a third order set array, and arranging, on the basis of the cumulative sum in the cumulative sum array corresponding to the entry value indicated by the value in the order set array, a global value number corresponding to entry value at a position indicated by the cumulative sum in the second global value number array, and arranging the value in the order set array and the value in the corresponding global order set array at positions indicated by the cumulative sum in the third order set array and the fourth global order set array, respectively, and wherein
at the data transmitting step, at least a second global value number array is transmitted as the value list, and at the data receiving step, second global value number arrays of the other memory modules are received as the value list, and
the method further comprises a fourth deciding step of judging a relative rank of the present memory module's value in the second global value number array with respect to the other memory modules with reference to each of the received second global value number arrays, and storing the rank in the global information block into a fifth global order set array equivalent to the global order storage array, and the rank of the sorted record is indicated by the value in the fifth global order set array.

27. The information processing method as claimed in claim 26, characterized in that the fourth deciding step further comprises generating an auxiliary order number array that stores relative value ranks in consideration of the second global value number array of each of the other memory modules, and adding the sum of the difference between the relative rank and the original rank judged for each of the other memory modules, to the original rank, thereby calculating the rank in the global information block.

28. An information processing system comprising a plurality of memory modules, each having a memory and a control device, and
a data transmission line that connects the memory modules and transmits a value of one memory module to another memory module, wherein
the memory of each memory module is arranged to hold a value list, and
the control device of each of the memory modules comprises:
data transmitting means that transmits a value contained in the value list to the other memory modules;
data receiving means that receives a value contained in the value list from the other memory modules; and
rank judging means that decides a global value rank in consideration of the values contained in the value lists of all the other memory modules, with reference to the value lists of the other memory modules received by the data receiving means, and stores the decided rank at a position corresponding to the value in the present memory module, in a global rank storage array for storing the global value rank.

29. An information processing method in an information processing system comprising the steps of:
(a) providing a plurality of memory modules, each having a memory and a control device, and
a data transmission line that connects the memory modules and transmits a value of one memory module to another memory module,
the memory of each memory module being arranged to hold a value list;
(b) transmitting a value contained in the value list to the other memory modules;
(c) receiving a value contained in the value list from the other memory modules; and
(d) deciding a global value rank in consideration of the values contained in the value lists of all the other memory modules, with reference to the value lists of the other memory modules received at the data receiving step, and storing the decided rank at a position corresponding to the value in the present memory module, in a global rank storage array for storing the global value rank.
